(19) United States
(12) Patent Application Publication
(10) Pub. No.: US 2011/0023281 A1
(43) Pub. Date: Feb. 3, 2011

(54) PEN INJECTION DEVICE CAP WITH INTEGRAL PEN NEEDLE QUICK RELEASE AND/OR REMOVAL SYSTEM

(75) Inventor: Steven Schraga, Surfside, FL (US)

Correspondence Address: GREENBLUM & BERNSTEIN, P.L.C., 1950 ROLAND CLARKE PLACE, RESTON, VA, 20191, US

(73) Assignee: STAT MEDICAL DEVICES, INC., North Miami, FL (US)

(21) Appl. No.: 12/770,303

(22) Filed: Apr. 29, 2010

Related U.S. Application Data
(60) Provisional application No. 61/174,308, filed on Apr. 30, 2009.

(51) Int. Cl. B23P 19/04

(52) U.S. Cl. 29/426.1; 29/240

(57) ABSTRACT

An injection device cap including a cap body configured to remove a pen needle installed on the injection device. A method of removing a pen needle from an injection device using the cap includes installing the pen needle onto a proximal end of an injection device and removing the pen needle using the cap. This Abstract is not intended to define the invention disclosed in the specification, nor intended to limit the scope of the invention in any way.

### CROSS-REFERENCE TO RELATED APPLICATIONS

The instant application is a US non-provisional application based on U.S. provisional application No. 61/174,308, filed Apr. 30, 2009, the disclosure of which is hereby expressly incorporated by reference hereto in its entirety.

### BACKGROUND OF THE INVENTION

1. Field of the Invention

This invention relates generally to pen injection devices, e.g., pre-loaded syringes, such are utilized for injection of medicament into the body tissues of human and animal patients. More specifically, this invention relates to a pen injection device having a removable pen needle which pen needle can be removed using the pen injection device cap. The cap can also be installed onto the pen injection device while the pen needle is installed on the pen injection device.

This invention also relates to pen needles for pen injection devices wherein the pen needle is configured to be used with the pen injection device and cap system.

This invention also relates to caps for pen injection devices which can be used to remove pen needles from the pen injection devices more safely, i.e., preventing the user from being pricked when handling and/or attempting to remove the pen needle from the pen injection device.

2. Discussion of Background Information

U.S. Pat. No. 4,973,318, the disclosure of which is hereby expressly incorporated by reference in its entirety, discloses a disposable syringe includes first and second housing elements which are coupled together for rotation without axial movement therebetween. The first housing element receives a cartridge of a solution to be injected, and mounts a liquid outlet needle at its front end. A piston rod is disposed in the second housing element to move axially therein, and this piston rod includes a rod element and a nut element. The rod element is coupled to the first housing element to move axially therein without relative rotation therewith, and the nut element is threaded to the rod element for telescoping movement therewith and is configured to move axially in the second housing element without relative rotation therein. A pressure receiving element is mounted on the nut element. The housing, rod, nut and pressure receiving elements cooperate such that relative rotation between the housing elements in a selected direction causes relative rotation between the nut and rod elements and thereby increases the effective length of the piston rod and causes the pressure receiving element to extend from the second housing element. A protective cap is removably mounted over the first housing element and is configured to abut second housing element while mounted in place on the first housing element. This protective cap is engaged with the first housing element such that rotation of the cap with respect to the second housing element causes rotation of the first housing element with respect to the second housing element.

This type of syringe is shown in FIGS. 1-7 wherein the pre-loaded syringe 1 has a proximal threaded end 2 which is configured to accept a needle tip assembly consisting of a needle tip 5, a needle tip cover 3, and a needle cover 4. As is evident from FIGS. 2 and 3, a user installs the needle tip assembly 3/4/5, after removing the assembly from its individual package, onto the threaded proximal end 2 by simply sliding it onto the end 2 axially. Because internal threads of the needle tip 5 are mounted to radially deflectable members, installation over threads of the end 2 occurs with a ratchet effect. This installation is made safe by the covers 4 and 5 which ensure that the user will not be pricked by the needle N. Once installed, the user can remove the needle tip cover 3 by simply sliding it off axially as is shown in FIG. 4. Next, as shown in FIG. 5, the user can remove the needle cover 4 to expose the needle N. The pen needle device then assumes the position shown in FIG. 6 and is made ready for use in providing an injection to the user. After injection, the user will typically remove the needle tip 5 and discard the same. To accomplish the removal, the user will typically reinstall the needle tip cover 3 and rotate it to cause the needle tip to unthread from the threaded end 2 (some users may even install the needle cover 4 prior to installing the cover 3). Once removed, however, it is still possible to reinstall the used needle tip 5 by simply repeating the steps noted above. FIG. 7 illustrates that the needle tip 5 can even be installed without the needle covers 3 and 4. Unless the user discards the needle tip 5, it is possible that she or other users will not remember or know that it has already been used. That is, there is nothing to prevent reuse of the needle tip 5 should someone attempt to reinstall the needle tip onto the end 2. Furthermore, if the user is unable to locate the covers 3 and 4 (i.e., if they have become lost), she must then attempt to grip the needle tip 5 in order to unthread it from the end 2. As is apparent, this action can be risky because the user can possibly inadvertently be pricked by the needle N either in attempting to properly grip the needle tip 5, in the action of rotating it to the point it is removed, or even in the handling of the needle tip 5 after it has been removed and prior to being properly discarded. Still further, if the needle tip 5 is not properly discarded (such as being correctly placed in a sharps container), others may come in contact with the needle tip 5 and possibly become injured thereby.

FIG. 8 shows a proximal end of a pen needle device with a removable protective cap according to the prior art. FIG. 9 shows a proximal end of a pen needle device with the removable protective cap removed according to the prior art.

It is desirable to provide a pen needle system which is safer to use compared to the conventional devices discussed above and/or which does not have one or more of the above-noted disadvantageous.

US 2008/0108951 to JERDE et al. discloses a pen injection device having a cap that can store an unused needle. The disclosure of this document is hereby expressly incorporated by reference in its entirety, whereby one or more of the disclosed features can be used in combination with the instant invention.

US 2007/0203458 to TSUBOTA discloses a pen injection device having a cap that can be used to remove the small pen needle safety cap. The disclosure of this document is hereby expressly incorporated by reference in its entirety, whereby one or more of the disclosed features can be used in combination with the instant invention.

US 2005/0283115 to GIAMBATTISTA et al., US 2005/0277895 to GIAMBATTISTA et al., US 2003/0014018 to GIAMBATTISTA et al., and US 2002/0133122 to GIAMBATTISTA et al. each discloses a pen injection device having a cap that includes an integral a safety needle guard. The disclosure of each of these documents is hereby expressly incorporated by reference in their entireties, whereby one or more of the disclosed features can be used in combination with the instant invention.

US 2004/0236284 to HOSTE et al. discloses a pen injection device having an integral a safety needle guard. The disclosure of this document is hereby expressly incorporated by reference in its entirety, whereby one or more of the disclosed features can be used in combination with the instant invention.

### SUMMARY OF THE INVENTION

According to one non-limiting embodiment of the invention, there is provided an injection device cap comprising a cap body configured to remove a pen needle installed on the injection device.

The cap body may comprise a plurality of mechanisms for engaging portions of the pen needle. The plurality of mechanisms may ensure that when a user rotates the cap body, the pen needle is caused to rotate or un-thread from an injection device. The plurality of mechanisms may comprise radial projections which engage with radial recesses of the pen needle. The plurality of mechanisms may comprise inwardly oriented radial projections which engage with external recesses of the pen needle.

The cap body may comprise a device for removing the pen needle from the cap body. The cap body may comprise a device for ejecting the pen needle from the cap body. The cap body may comprise a device for ejecting the pen needle from within the cap body. The cap body may comprise a user activated device for ejecting the pen needle from within the cap body. The cap body may comprise a clip for removably securing an injection device to a user's garment.

The cap body may be installable onto an injection device when with the pen needle is installed on the injection device. The cap body may not rotatably engage with the pen needle when a needle cap of the pen needle is installed thereon and may rotatably engage with the pen needle when the needle cap of the pen needle is removed. The cap body may comprise a user activated device for ejecting the pen needle from within the cap body.

The cap body may rotatably engage with the pen needle when a needle cap of the pen needle is removed and may not rotatably engage with the pen needle when the needle cap of the pen needle is not removed.

The cap body may comprise a device for indicating to a user that the cap body is and/or is not rotatably engaged with the pen needle. The cap body may comprise a visual indicator which indicates to a user that the cap body is and/or is not rotatably engaged with the pen needle.

The cap body may comprise a system for preventing rotatable engagement with the pen needle when a needle cap of the pen needle is installed thereon and for automatically causing rotatable engagement with the pen needle when the needle cap of the pen needle is removed. The cap body may comprise a user activated device for ejecting the pen needle from within the cap body. The cap body may comprise a system for preventing rotatable engagement with the pen needle when a needle cap of the pen needle is installed thereon and a system for automatically causing rotatable engagement with the pen needle when the needle cap of the pen needle is removed.

The cap body may comprise a two-part cap body. The cap body may comprise a user activatable system for preventing engagement with the pen needle and for causing engagement with the pen needle. The cap body may comprise a user activatable system for preventing locking engagement with the pen needle and for causing locking engagement with the pen needle. The cap body may comprise a user activatable system for causing locking engagement between the cap body and the pen needle.

The cap body may comprise a three-part cap body. At least two parts of the three-part cap body may slide with respect to one another. At least two parts of the three-part cap body may be arranged to telescopically slide with respect to one another. At least two parts of the three-part cap body may be arranged to rotate freely with respect to one another in one position and to prevent relative rotation in another position. At least two parts of the three-part cap body may be arranged to rotate freely with respect to one another in one position and to releasably lock together in another position. At least two of parts of the three-part cap body may be connected to each other via a threaded connection.

The injection device may be one of a pre-filed injection device, a pen injection device, and an insulin injection device.

The invention also provides for a method of removing a pen needle from an injection device using the cap described above, wherein the method comprises installing the pen needle onto a proximal end of an injection device and removing the pen needle using the cap.

The invention also provides for a pre-filled injection device comprising at least one feature shown in at least one drawing of the instant application.

The invention also provides for a pre-filled injection device comprising at least one feature described in the instant application.

The invention also provides for a pre-filled injection device comprising a pre-filled injection device body and a removable cap configured to remove a pen needle installed on the pre-filled injection device body.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an enlarged partial side view of a proximal end of a prior art pen needle device or pre-loaded syringe/injection device. The proximal end is shown with the cap removed and in a prior-use state, i.e., it is ready to receive thereon a needle tip or pen needle;

FIG. 2 shows the proximal end of FIG. 1 along with a prior art needle tip assembly in a position prior to installation onto the proximal end. The needle tip cap and the needle cap are both shown in cross-section;

FIG. 3 shows the proximal end and prior art needle tip assembly of FIG. 2 after installation of the needle tip assembly onto the proximal end;

FIG. 4 shows how the needle tip cap can be removed from the prior art needle tip assembly of FIG. 3;

FIG. 5 shows how the needle cap can be removed from the prior art needle tip of FIG. 4;

FIG. 6 shows the needle tip mounted onto the pen needle device in a position ready for injection according to the prior art;

FIG. 7 shows the needle tip being removed from the pen needle device according to the prior art. This would occur after use and can occur by unthreading the needle tip from the threaded proximal end of the pen needle device. The arrow illustrates that it is possible to re-install the needle tip onto the threaded proximal end of the pen needle device;

FIG. 8 shows a proximal end of a pen needle device with a removable protective cap according to the prior art;

FIG. 9 shows a proximal end of a pen needle device with the removable protective cap removed according to the prior art;

FIG. 10 shows a side view of a removable cap for a pen needle device according to a first non-limiting embodiment of the invention;

FIG. 11 shows a side cross-section view of the removable cap shown in FIG. 10;

FIG. 12 shows a distal end view of the removable cap shown in FIG. 10;

FIG. 13 shows a side view of the removable cap of FIG. 10 installed onto the proximal end of a prior art pen needle device or pre-filled syringe;

FIG. 14 shows a side view of the proximal end of a pen needle device with the pen needle installed thereon according to the prior art. The small needle cap is installed on the pen needle thereby indicating that the pen needle has not yet been used;

FIG. 15 shows a side view of the cap of FIG. 10 installed onto the proximal end of a prior art pen needle device or pre-filled syringe shown in FIG. 14;

FIG. 16 shows a side view of a proximal end of a pen needle device with the pen needle installed thereon according to the prior art. The small needle cap is removed from the pen needle thereby indicating that the pen needle has been used;

FIG. 17 shows a side view of the cap of FIG. 10 installed onto the proximal end of a prior art pen needle device or pre-filled syringe shown in FIG. 16;

FIG. 18 shows a side view of the cap of FIG. 10 being rotated and removed from the proximal end of a prior art pen needle device or pre-filled syringe shown in FIG. 16;

FIG. 19 shows a side cross-section view of the cap of FIG. 10 after being removed from the proximal end of a prior art pen needle device or pre-filled syringe shown in FIG. 16 and shows the pen needle being retained within the cap;

FIG. 20 shows the cap of FIG. 19 after a user activates a mechanism for ejecting the pen needle from engagement within the cap;

FIG. 21 shows a side cross-section view of a removable cap for a pen needle device according to another non-limiting embodiment of the invention. This embodiment is similar to that of FIG. 10 except that it additionally includes a spring for biasing the ejecting mechanism;

FIG. 22 shows a side cross-section view of a removable cap for a pen needle device according to another non-limiting embodiment of the invention. The ejecting mechanism is shown in an initial or retracted position;

FIG. 23 shows another side cross-section view of the removable cap shown in FIG. 22. The ejecting mechanism is shown in an ejection or extended position;

FIG. 24 shows a side cross-section view of a removable cap for a pen needle device according to another non-limiting embodiment of the invention. This embodiment is similar to that of FIG. 10 except that it additionally includes a spring for biasing the ejecting mechanism. In FIG. 24, the position of the ejection mechanism provides an indication to the user that the pen needle has not yet been used;

FIG. 25 shows another side cross-section view of the removable cap of FIG. 24. In FIG. 25, the position of the ejection mechanism provides an indication to the user that the pen needle has been used;

FIG. 26 shows a side view of a removable cap for a pen needle device according to another non-limiting embodiment of the invention. In FIG. 26, a system is shown automatically engaging with the pen needle after the pen needle has been used;

FIG. 27 shows another side view of the removable cap of FIG. 26. In FIG. 27, the system is shown not yet engaging with the pen needle as a result of the pen needle not yet being used;

FIG. 28 shows a side cross-section view of the removable cap shown in FIG. 26 after it is removed from the pen needle device and after the pen needle is removed from within the removable cap;

FIG. 29 shows a side cross-section view of a main body portion of the removable cap shown in FIG. 28;

FIG. 30 shows a cross-section view through arrows in FIG. 29;

FIG. 31 shows a side cross-section view of an engaging member used in the removable cap shown in FIG. 28;

FIG. 32 shows a distal end view of the member shown in FIG. 31;

FIG. 33 shows a proximal end view of the member shown in FIG. 31;

FIG. 34 shows a side cross-section view of a spring used in the removable cap shown in FIG. 28;

FIG. 35 shows a side cross-section view of an optional engaging member that can be used in the removable cap shown in FIG. 28;

FIG. 36 shows a distal end view of the member shown in FIG. 35;

FIG. 37 shows a proximal end view of the member shown in FIG. 35;

FIG. 38 shows a side cross-section view of a removable cap for a pen needle device according to another non-limiting embodiment of the invention. In FIG. 38, a system is shown automatically engaging with the pen needle after the pen needle has been used and after the removable cap is removed from the pen needle device;

FIG. 39 shows another side cross-section view of the removable cap of FIG. 38. In FIG. 39, the system is shown disengaging with the pen needle as a result of the movement of the ejecting mechanism;

FIG. 40 shows a side view of the removable cap shown in FIG. 38 with the pen needle removed;

FIG. 41 shows a side cross-section view of an engaging member used in the removable cap shown in FIG. 40;

FIG. 42 shows a distal end view of the member shown in FIG. 41;

FIG. 43 shows a proximal end view of the member shown in FIG. 41;

FIG. 44 shows a side cross-section view of another non-limiting embodiment of a removable cap according to the invention. The device is similar to that of FIG. 28 and utilizes a two-part main body;

FIG. 45 shows a side cross-section view of the removable cap of FIG. 44 with a pen needle arranged therein;

FIG. 46 shows a side cross-section view of the removable cap of FIG. 45 with a proximal part of the two-part main body being separated from the distal part thereof;

FIG. 47 shows a side view of a removable cap installed on a pen needle injection device according to another non-limiting embodiment of the invention. In FIG. 47, a system is shown automatically engaging with the pen needle after the pen needle has been used and after the removable cap is installed on the pen needle device;

FIG. 48 shows another side view of FIG. 47. In FIG. 48, the system is shown non-engaged with the pen needle as a result of the injection not yet being used;

FIG. 49 shows another side view of the removable cap of FIG. 47, but removed from the injection device. In FIG. 49, the system is shown engaged with the pen needle indicating that the removable cap has been under to remove the pen needle from the injection device;

FIG. 50 shows another side view of FIG. 49. In FIG. 50, the system is shown disengaged with the pen needle as a result of the user moving a push-button along the direction of the arrow and showing how to disengage and eject the pen needle from within the removable cap;

FIG. 51 shows a side view of the removable cap of FIG. 50 with the pen needle removed;

FIG. 52 shows an enlarged partial side cross-section view of a main body portion of the removable cap shown in FIG. 51;

FIG. 53 shows a cross-section view through arrows in FIG. 52;

FIG. 54 shows a side view of a push-button actuator used in the removable cap shown in FIG. 51;

FIG. 55 shows a side cross-section view of FIG. 54;

FIG. 56 shows a side cross-section view of an engaging member used in the removable cap shown in FIG. 51;

FIG. 57 shows a distal end view of the member shown in FIG. 56;

FIG. 58 shows a proximal end view of the member shown in FIG. 56;

FIG. 59 shows a side cross-section view of a removable cap for a pen needle device according to another non-limiting embodiment of the invention. In FIG. 59, a system is shown automatically engaging with the pen needle after the pen needle has been used and after the removable cap is removed from the pen needle device;

FIG. 60 shows another side cross-section view of the removable cap of FIG. 59. In FIG. 60, the system is shown disengaging with the pen needle as a result of the movement of the ejecting mechanism along the direction of the arrow;

FIG. 61 shows an enlarged partial side cross-section view of 59;

FIG. 62 shows a side cross-section view of another non-limiting embodiment of a removable cap according to the invention. The device utilizes a three-part main body. In FIG. 62, the system for engaging with the pen needle is shown non-engaged therewith;

FIG. 63 shows another side cross-section view of the removable cap of FIG. 62. In FIG. 63, the system for engaging with the pen needle is shown in an engaged position;

FIG. 64 shows an enlarged partial side cross-section view of a modified version of the embodiment of FIG. 62; and

FIG. 65 show one non-limiting way in which the removable cap of the types described herein can be releasably connected to a pen needle device.

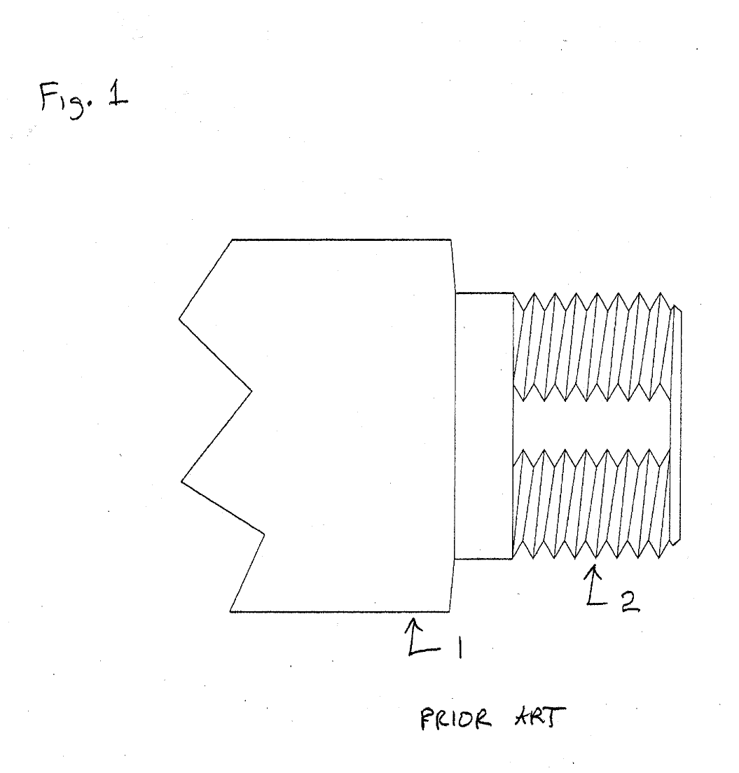

### DETAILED DESCRIPTION OF THE INVENTION

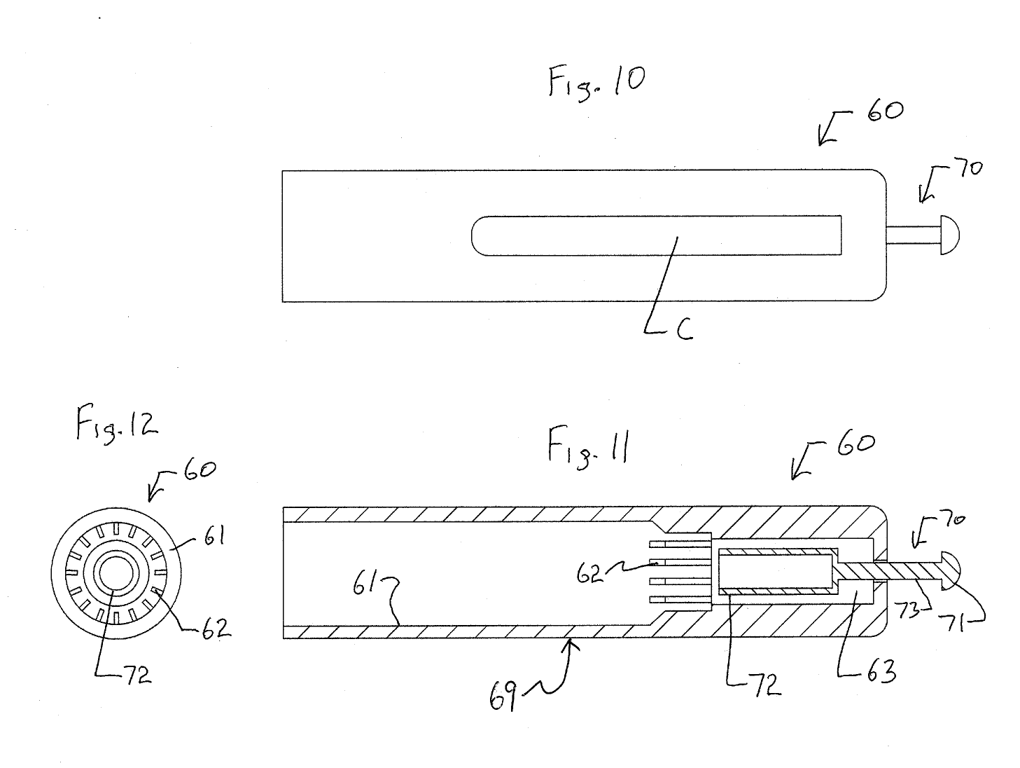

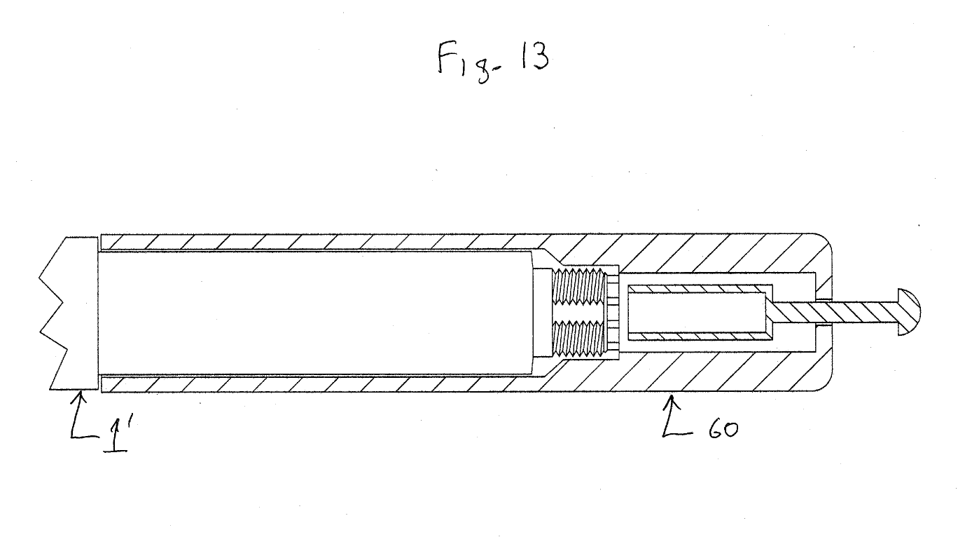

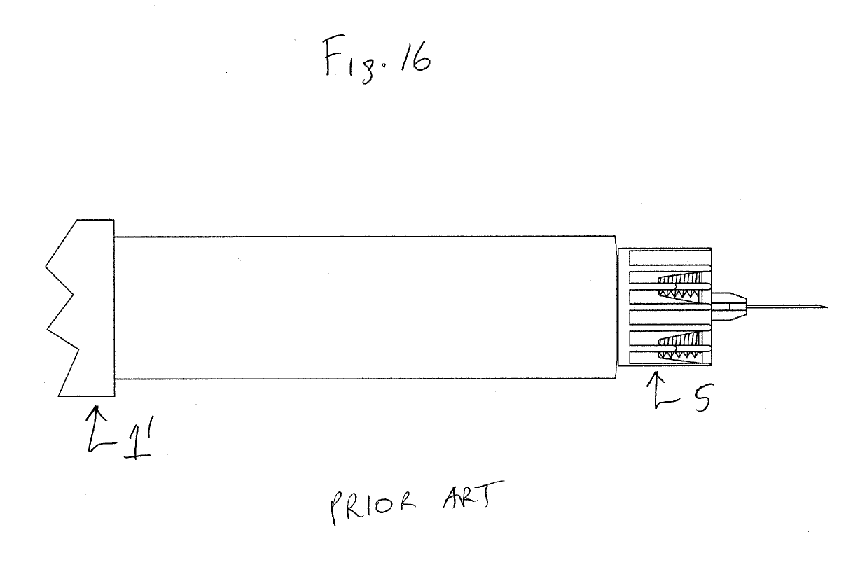

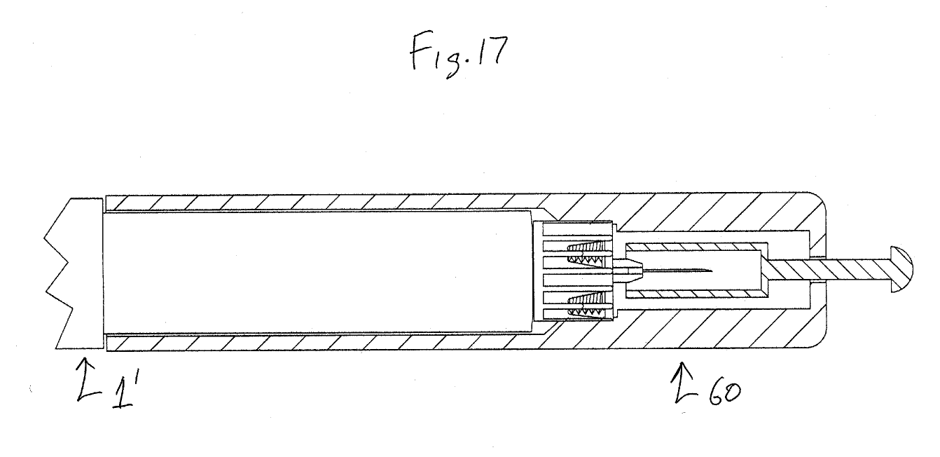

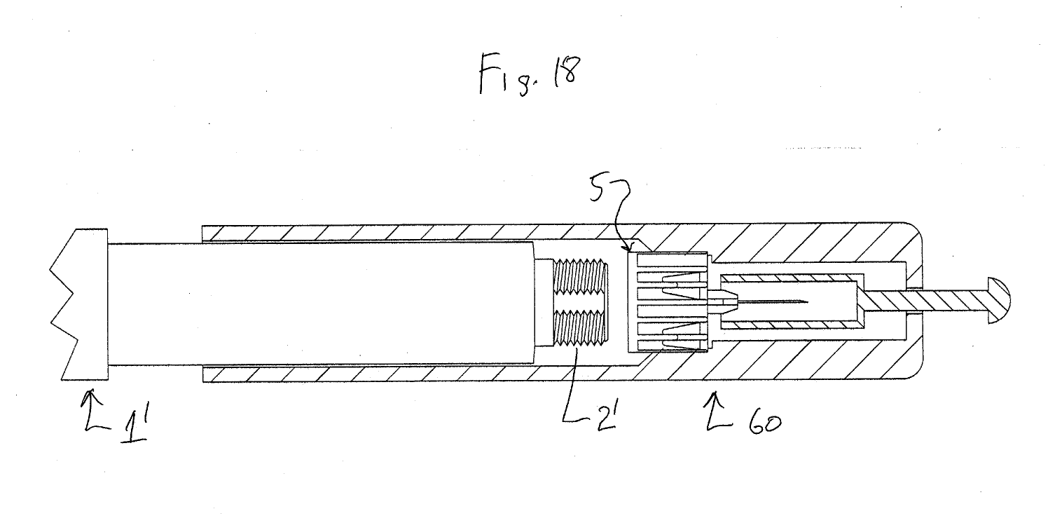

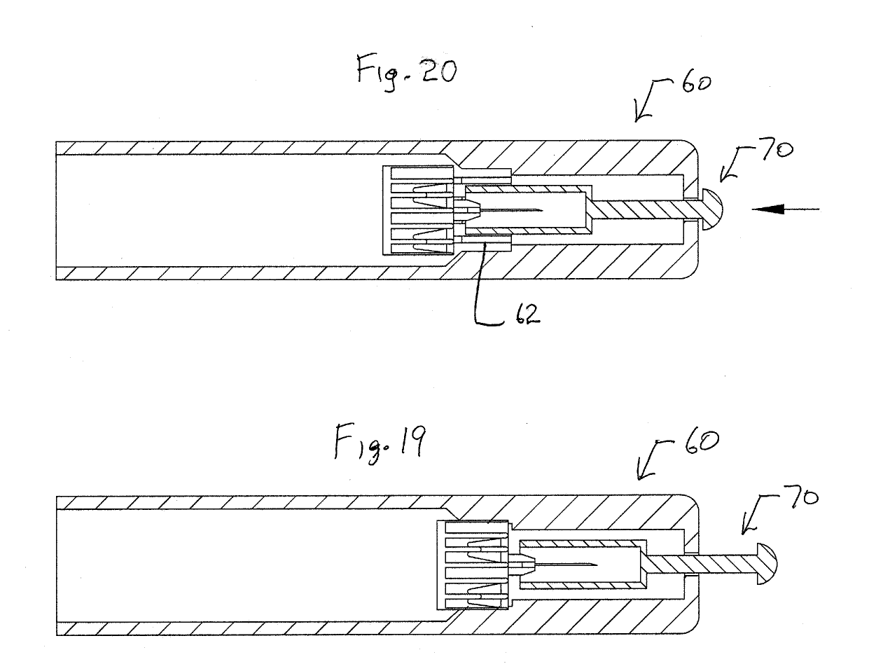

Referring now to the drawings and first to FIGS. 10-20 which shows a first embodiment of a removable cap or removable cap assembly according to the invention. The removable cap 60 includes a generally cylindrical main body 69. In embodiments, the main body 69 is a one-piece integrally formed member. A clip C is coupled to the main body 69 so as to allow for clipping onto a user. The main body 69 also includes a generally cylindrical section 61 sized and configured to slide onto a proximal end of a pen injection device 1′ (see FIG. 13). The main body 69 also includes a plurality of generally radially oriented ribs 62 sized and configured to engage with a plurality of recesses and/or spaces between plural projections of the pen needle 5 (see FIG. 15). The main body 69 further also includes another generally cylindrical section 63 sized and configured to movingly receive therein a distal portion 72 of an ejection member 70 (see FIG. 11). The ejection member 70 has a portion 73 that slidably moves within a through opening formed in a proximal end of the removable cap 60. A push-button 71 extends outside the removable cap 60 and is sized and configured to be depressed by a user when the user wishes to cause ejection (see FIG. 20) of the pen needle 5 from within the cap 60.

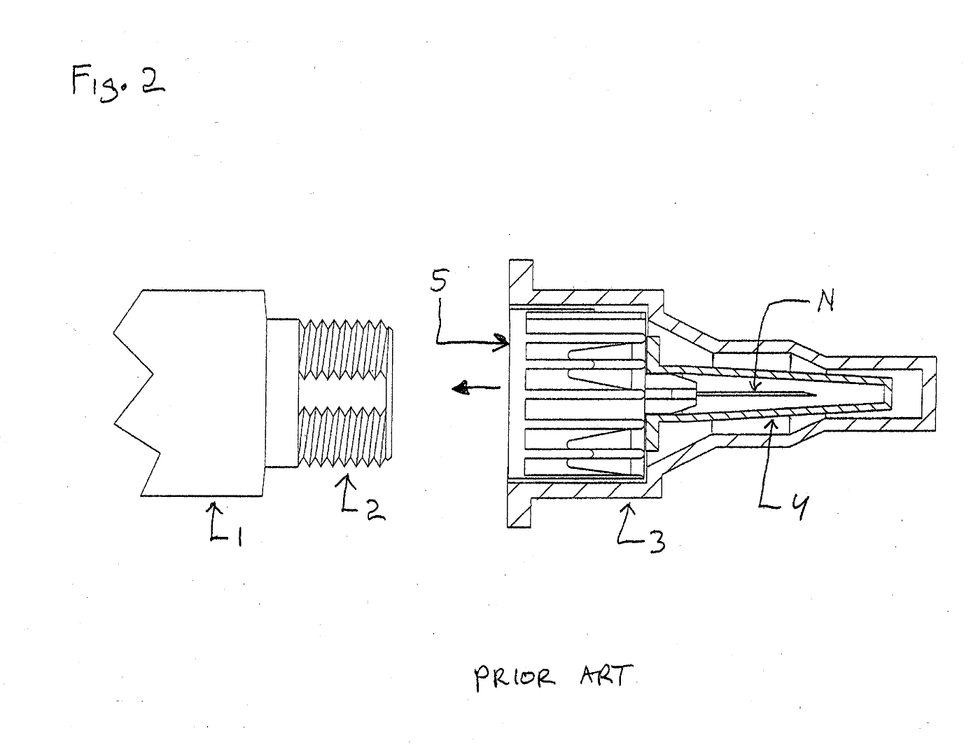

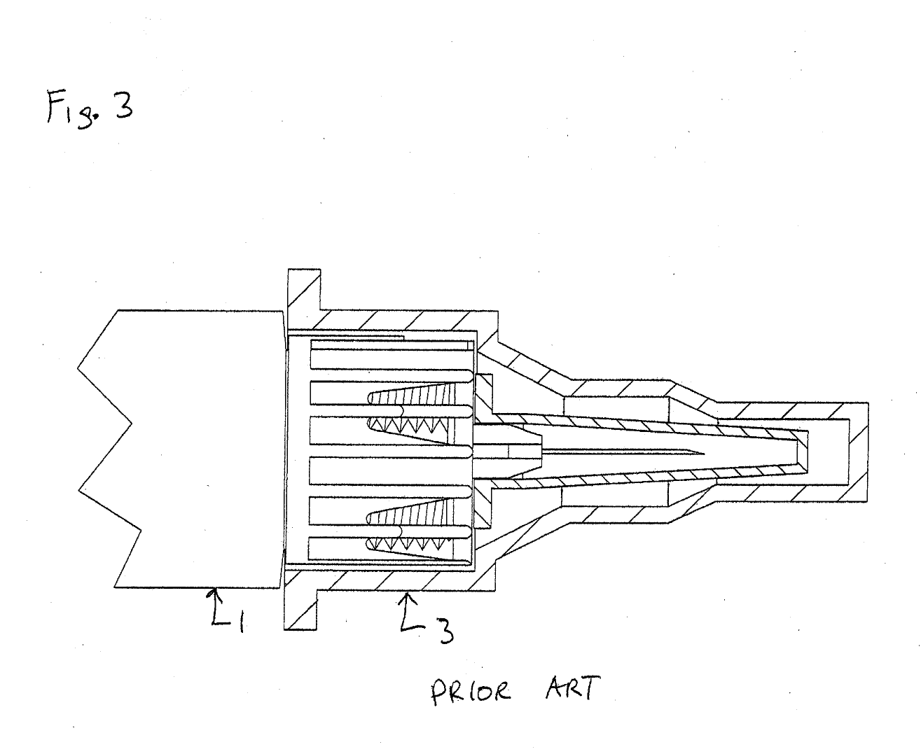

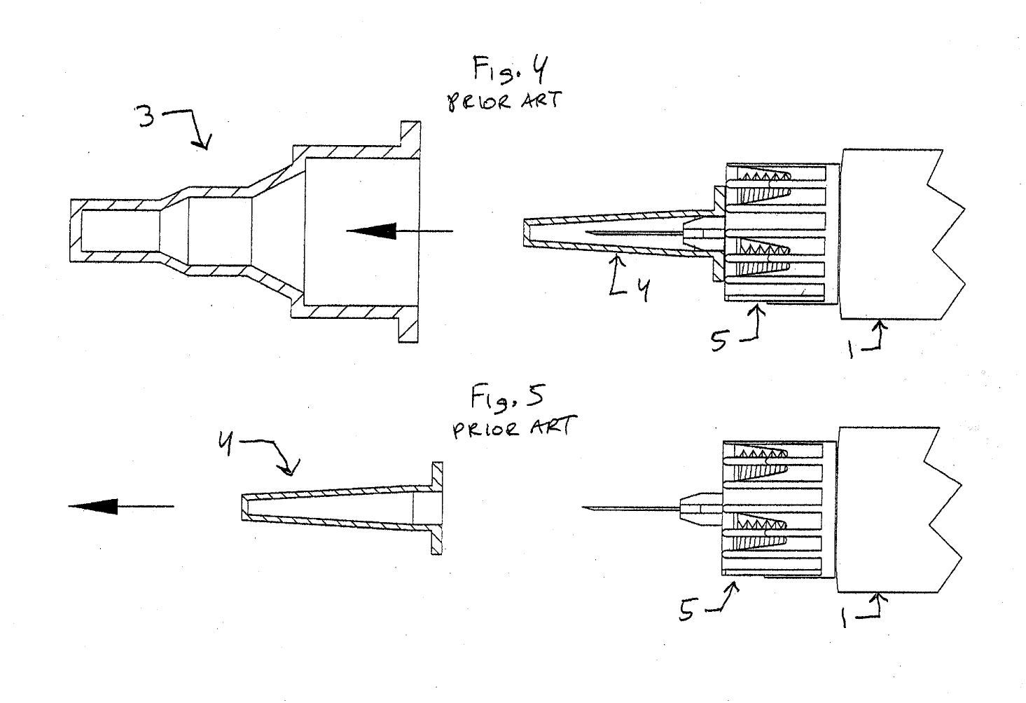

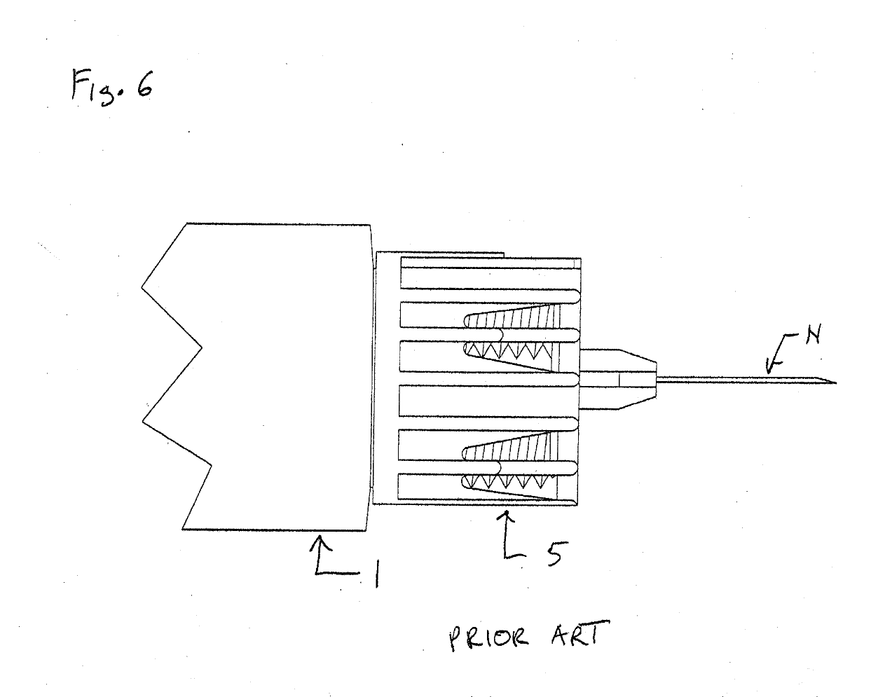

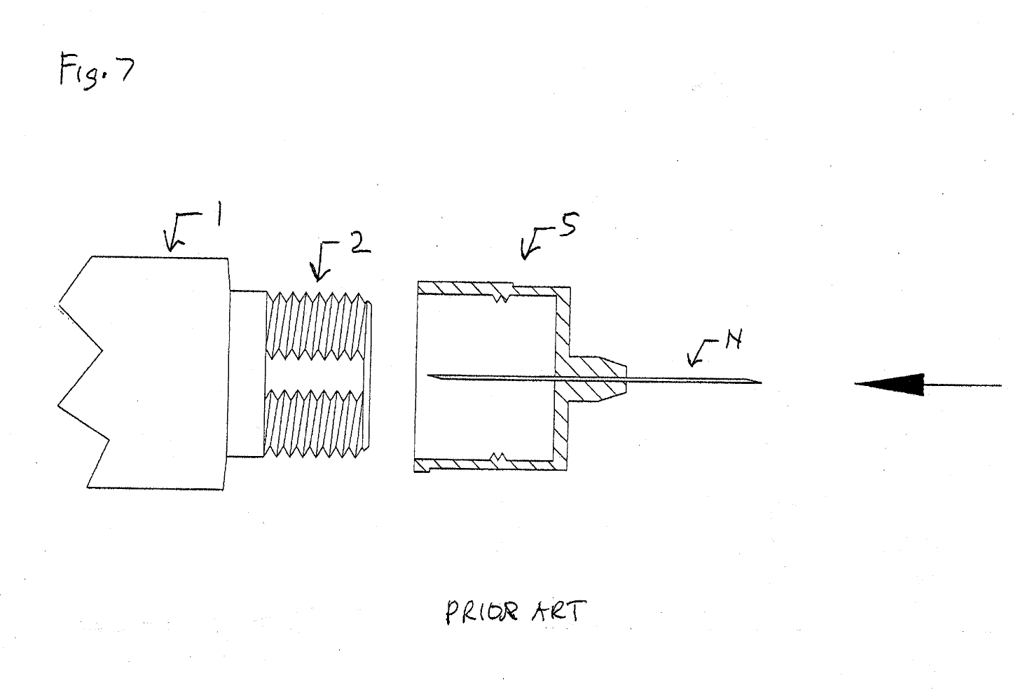

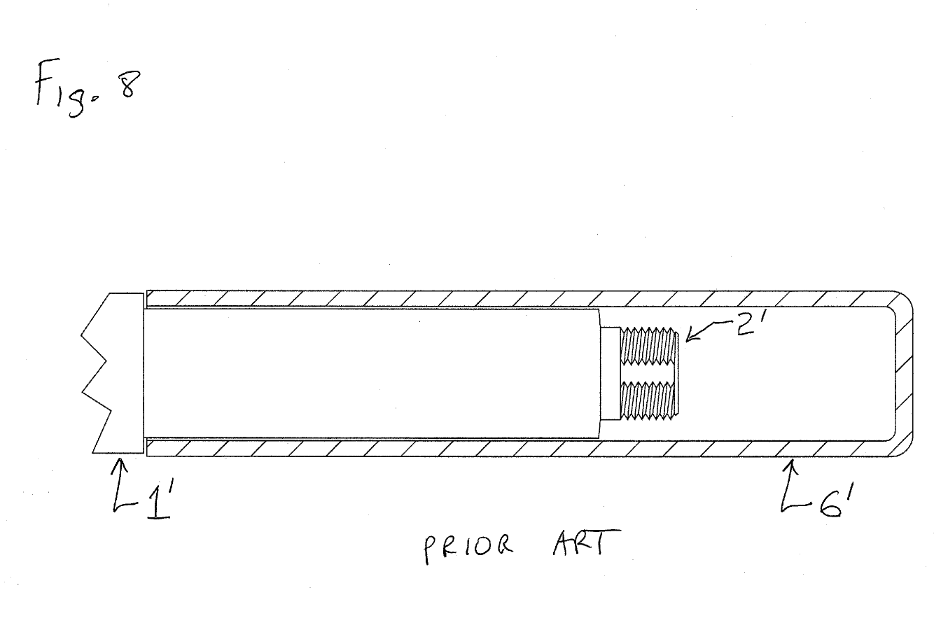

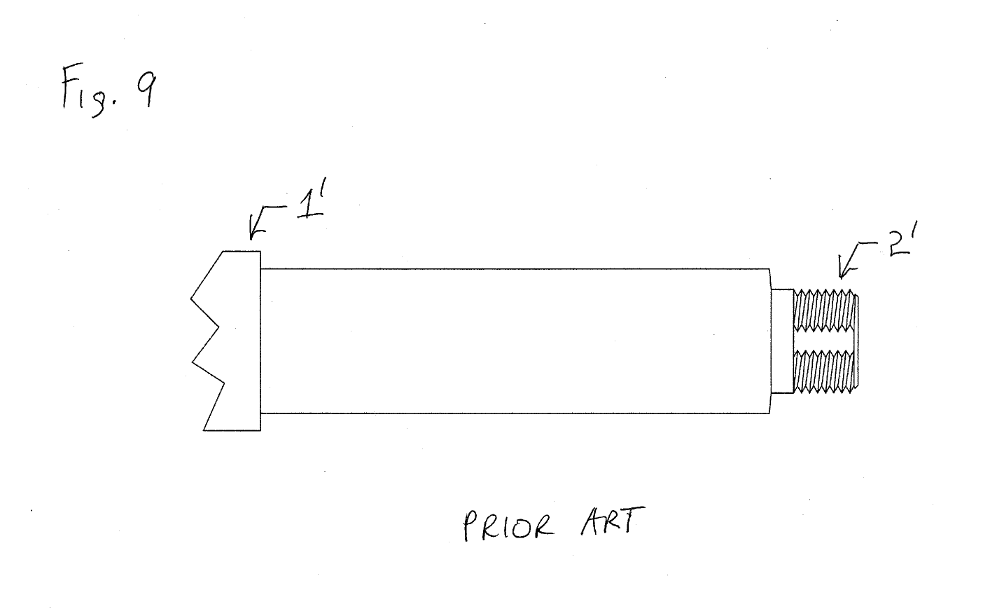

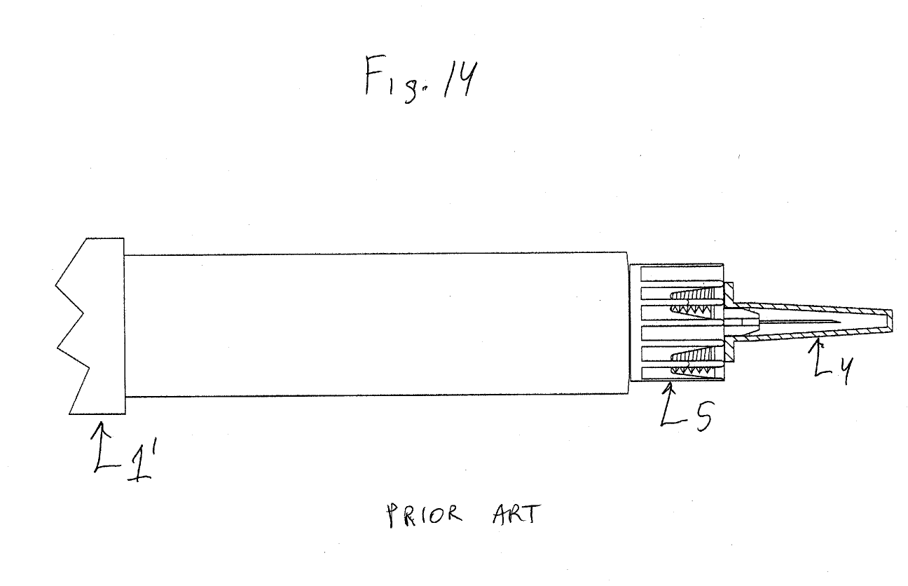

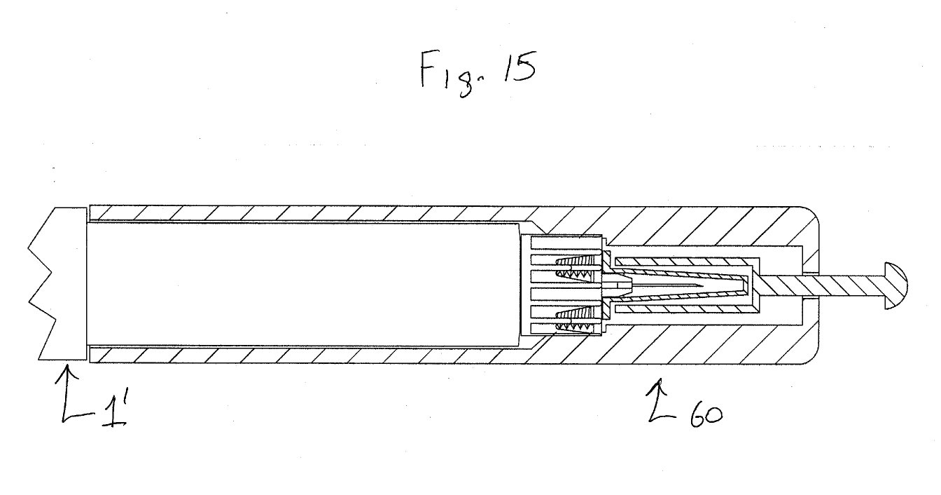

The engagement between the ribs 62 and the exterior surface of the pen needle 5 is such that the removable cap 60 can be slid off and onto the injection device 1′ axially under various conditions. FIG. 13 illustrates how the removable cap 60 can be slid onto the injection device 1′ without the ribs 62 contacting and/or interfering with the threaded proximal end 2′ in a manner similar to that of the prior art (see FIG. 8). The position/configuration of FIG. 13, wherein the injection device 1′ has installed thereon the removable cap 60, is characteristic of a storage configuration, an initial use configuration, and/or a shipping or packaged configuration. Once the user removes the removable cap 60, the user can installed a pen needle 5 (in a manner similar to that shown in FIGS. 2-4) in order to place the injection device in a pre-ready-to-use configuration as shown in FIG. 14. To then use the device shown in FIG. 14 for injection, the user simply removes the safety cap 4 and then injects the needle of the pen needle 5 while the device has the configuration shown in FIG. 16. However, it is also possible to re-install the removable cap 60 while the device is in the pre-ready-to-use configuration as shown in FIG. 14, as shown in FIG. 15. To then use the device shown in FIG. 15 for injection, the user simply removes the removable cap 60, followed by the safety cap 4. Once the device assumes the configuration shown in FIG. 16, the needle of the pen needle 5 can then be injected. Once the device is used for injection, the user can re-install the removable cap 60 while the user pen needle 5 is still installed on the device 1′ (see FIG. 17). This renders the device safe or safer to handle as the removable cover 60 serves to cover the needle of the pen needle 5. The user can then use removable cap 60 to remove the used pen needle 5 from the device 1′. As is apparent from a comparison of FIG. 17 and FIG. 18, since the ribs 62 engage with the pen needle 5, all the user need do to remove the pen needle 5 from the device 1′ is to rotate the removable cap 60 along a direction that causes the threads of the pen needle 5 to unthread from section 2′ of the device 1′. Once fully unthreaded (see FIG. 18), the removable cap 60 with the used pen needle 5 safely arranged within can be removed from the device 1′ and thereby assume the configuration shown in FIG. 19. At this point, the user can cause the pen needle 5 to be ejected from within the removable cap 60 simply by depressing or moving the member 70 generally along the direction of arrow in FIG. 20. Ejection occurs when the distal end of the member 70 contacts a proximal surface of the body of the pen needle 5 as pushes against the same. Since the only mechanism retaining the pen needle 5 within the removable cap 60 are the ribs 62 (which frictionally engage with the external surface of the pen needle 5), movement of the member 70 along the distal axial direction indicated by arrow in FIG. 20 eventually results in the pen needle 5 disengaging from the ribs 62. At this point, the pen needle 5 can simply fall out of the removable cap 60 (by the user tipping the cap 60 to the point where the open end is lower than the closed end), and is preferably dropped into a sharps container for safe disposal. Once the used pen needle 5 is removed from the removable cap 60, the user can place the cap 60 back onto the injection device 1′ so that the device once again assumes the configuration shown in FIG. 13.

FIG. 21 shows a side cross-section view of a removable cap 60′ installable on a pen needle device 1′ according to another non-limiting embodiment of the invention. This embodiment is similar to that of FIG. 10 except that it additionally includes a spring S1 for biasing the ejecting mechanism 70′ towards an initial position. The spring S1 ensures that when the user moves the member 70′ along the direction of arrow shown in FIG. 20 and then stops depressing the member 70′, the member 70′ automatically moves back to the initial position shown in FIG. 21.

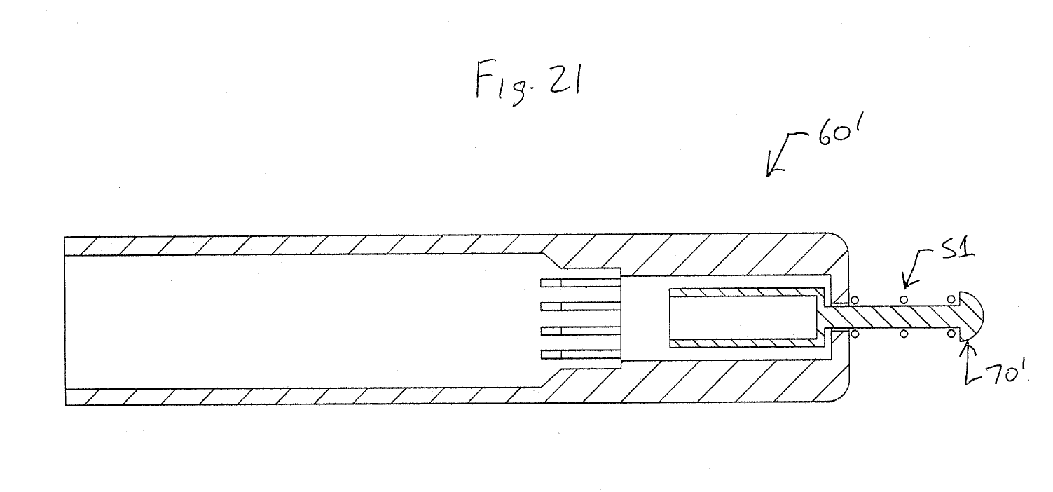

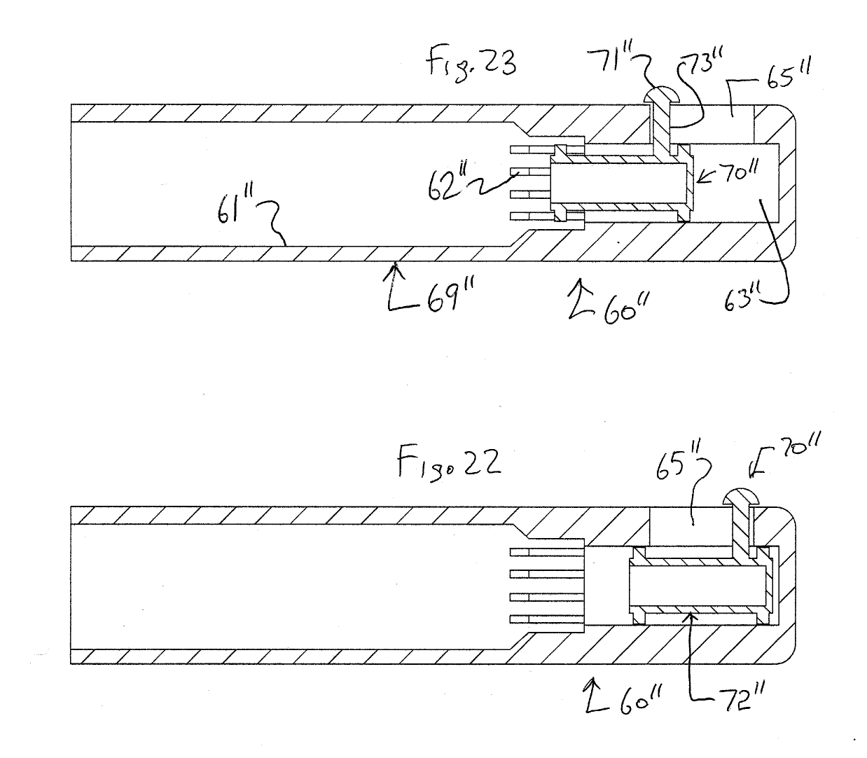

FIGS. 22 and 23 show another embodiment of a removable cap or removable cap assembly according to the invention. The removable cap 60″ includes a generally cylindrical main body 69″. In embodiments, the main body 69″ is a one-piece integrally formed member. A clip C (not shown but similar to of FIG. 10) that is coupled to the main body 69″ so as to allow for clipping onto a user. The main body 69″ also includes a generally cylindrical section 61″ sized and configured to slide onto a proximal end of a pen injection device 1′ (see e.g., FIG. 13). The main body 69″ also includes a plurality of generally radially oriented ribs 62″ sized and configured to engage with a plurality of recesses and/or spaces between plural projections of the pen needle 5 (see e.g., FIG. 15). The main body 69″ further also includes another generally cylindrical section 63″ sized and configured to movingly receive therein a main portion 72″ of an ejection member 70″. The ejection member 70″ has a portion 73″ that slidably moves within a through slot 65″ formed in a side of the removable cap 60″. A push-button 71″ extends outside the removable cap 60″ and is sized and configured to be slid forwards and back by a user when the user wishes to cause ejection (by moving member 70″ to the position shown in FIG. 23) of the pen needle 5 from within the cap 60″. In FIG. 22, the ejection member 70″ is in an initial position.

FIGS. 24 and 25 show a removable cap 60′″ installable on a pen needle device 1′ according to another non-limiting embodiment of the invention. This embodiment is similar to that of FIG. 10 except that it additionally includes a spring S2 for biasing the ejecting mechanism 70′″ towards an ejection position. In FIG. 24, the position of the ejection mechanism 70′″ provides an indication to the user that the pen needle 5 has not yet been used. When the user installs the pen needle 5 onto the injection device 1′, it typically occurs with the safety cap 4 installed thereon. With the safety cap 4 installed, the member 70′″ will protrude out past the proximal end of the cap 60′″ in FIG. 24. This provides a visual indicator to the user. In FIG. 25, the position of the ejection mechanism 70′″ provides an indication to the user that the pen needle 5 has been used. When the user uses the pen needle 5 on the injection device 1′, it occurs with the safety cap 4 removed. Re-installing the cap 60′″ on the device 1′ with the safety cap 4 removed from the pen needle 5 allows the member 70′″ to assume the position shown in FIG. 25. According to this embodiment, the user can remove the pen needle 5 from the injection device 1′ can take place in the conventional manner after or before the user re-installs the cap 60′″. Alternatively, the user can rotate the cap 60′″ to cause unthreading of the pen needle 5 from the device 1′ and then subject the cap 60′″ to a shaking movement until the pen needle 5 disengages from the ribs and falls out of the cap 60′″ so that it can be safely discarded.

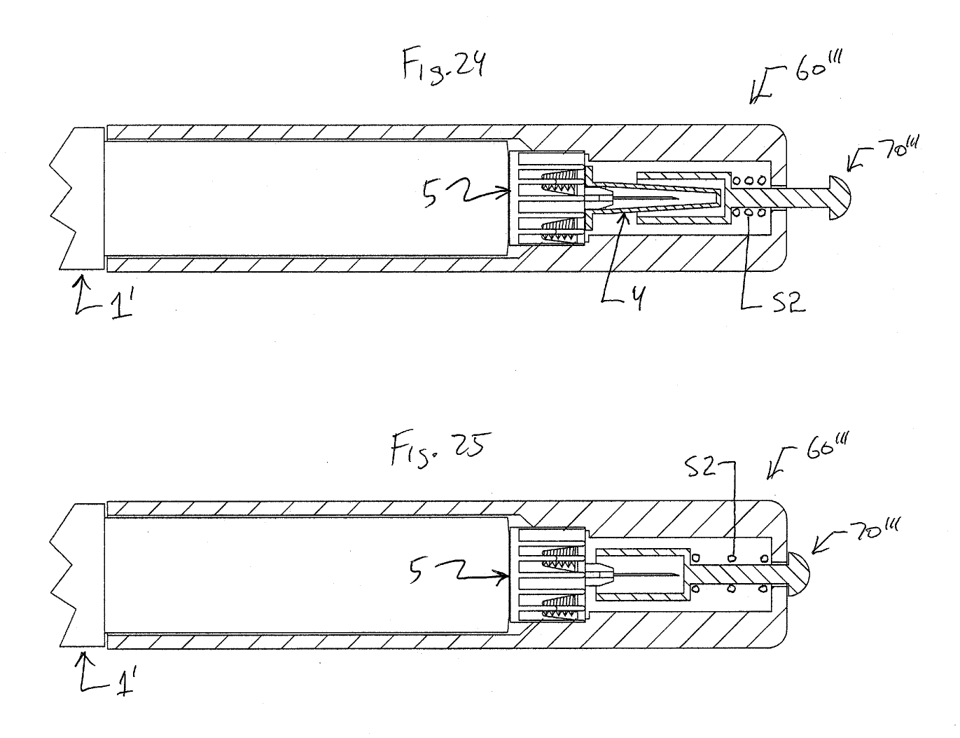

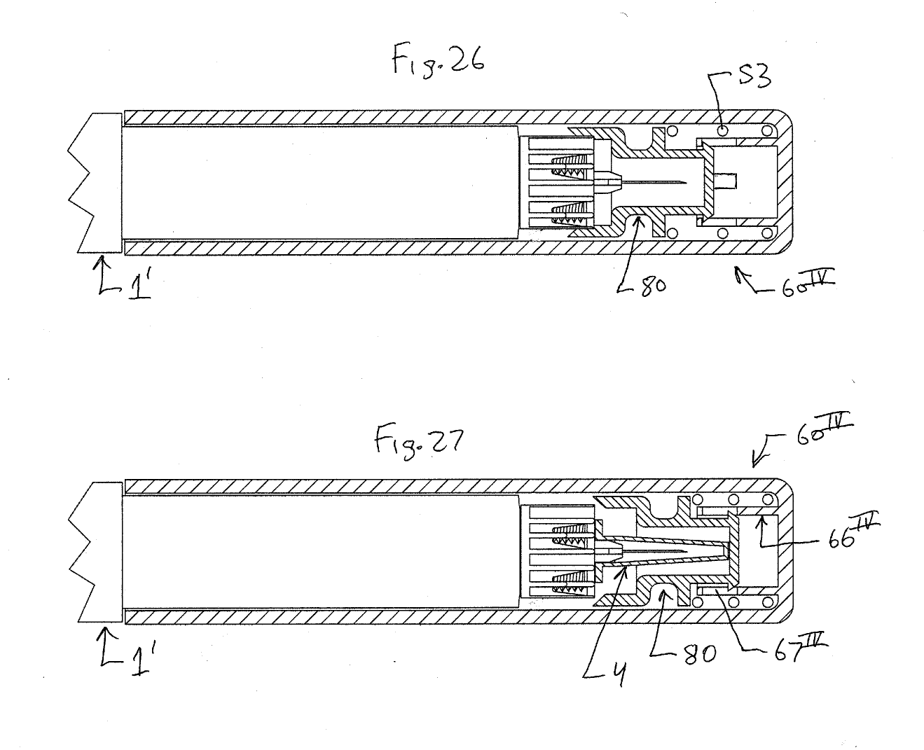

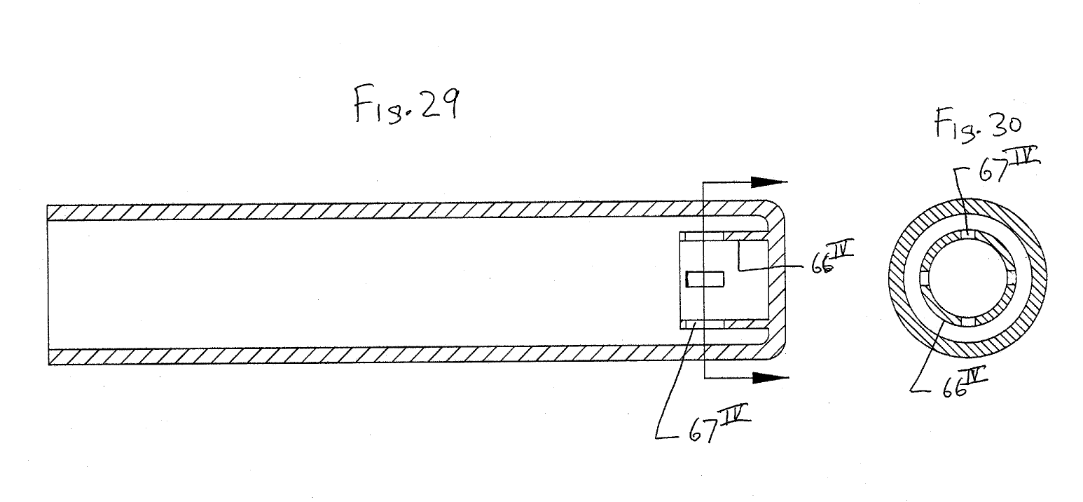

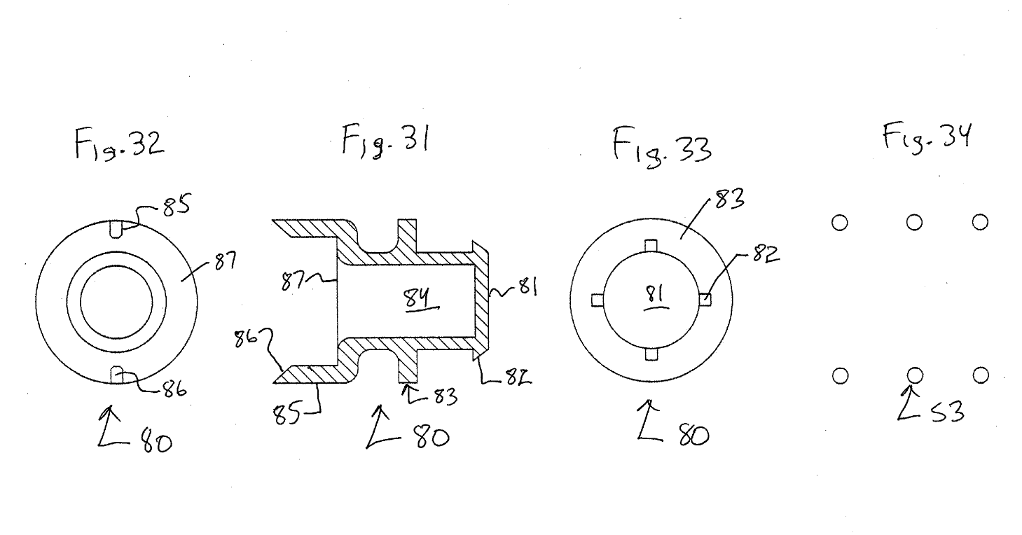

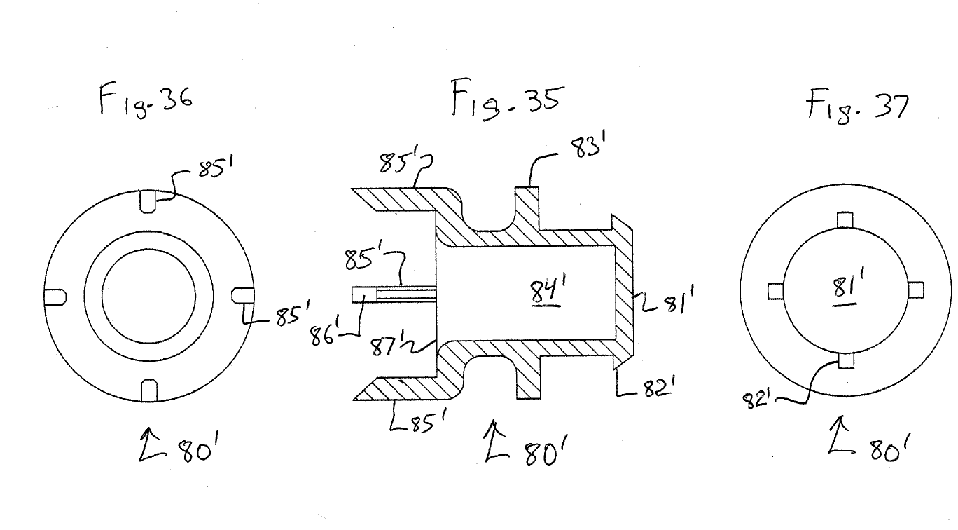

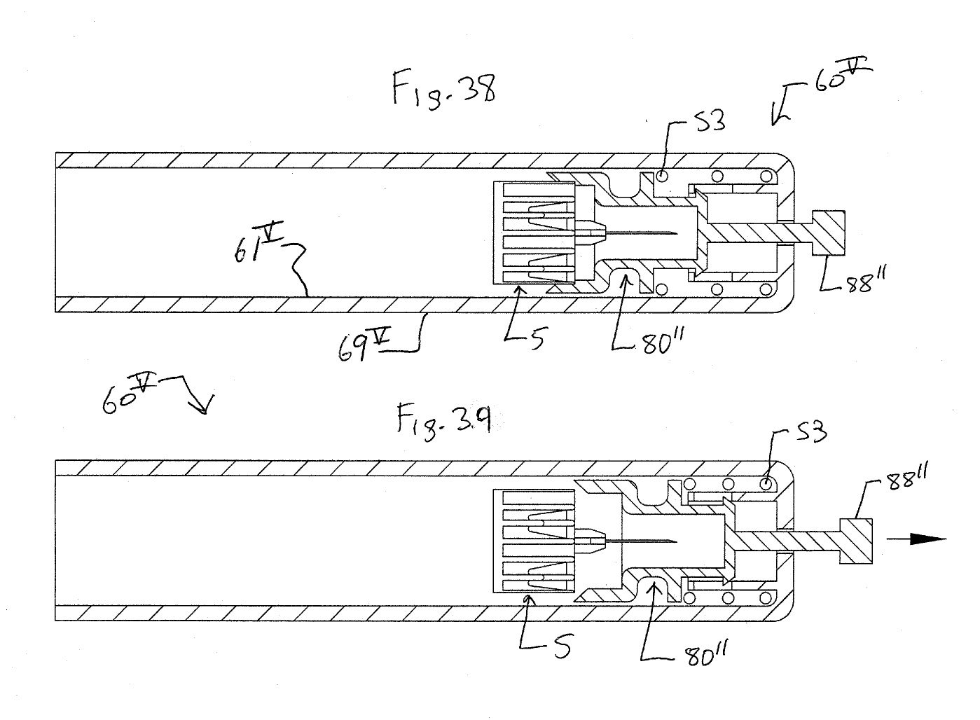

FIGS. 26-34 show another embodiment of a removable cap or removable cap assembly according to the invention. The removable cap 60^{IV} includes a generally cylindrical main body 69^{IV}. In embodiments, the main body 69^{IV} is a one-piece integrally formed member. A clip C (not shown) is coupled to the main body 69^{IV} so as to allow for clipping onto a user. The main body 69^{IV} also includes a generally cylindrical section 61^{IV} sized and configured to slide onto a proximal end of a pen injection device 1′ (see FIGS. 26 and 27). The main body 69^{IV} also includes an inner support 66^{IV} having a plurality of generally radially oriented slots 67^{IV} sized and configured to slidably receive therein a plurality of projections 82 arranged on an engaging member 80. A spring S3 biases the engaging member 80 towards the engaging position (see FIG. 26) wherein engaging members 85 engage with recesses formed on the pen needle 5. As shown in FIGS. 31-33, the engaging member 80 includes a proximal end 81, a support ring 83, a main generally cylindrical open area 84, a distal end 87, plural engaging members 85, i.e., two engaging members, having tapered ends 86, and can slide within the cap 60^{IV}.

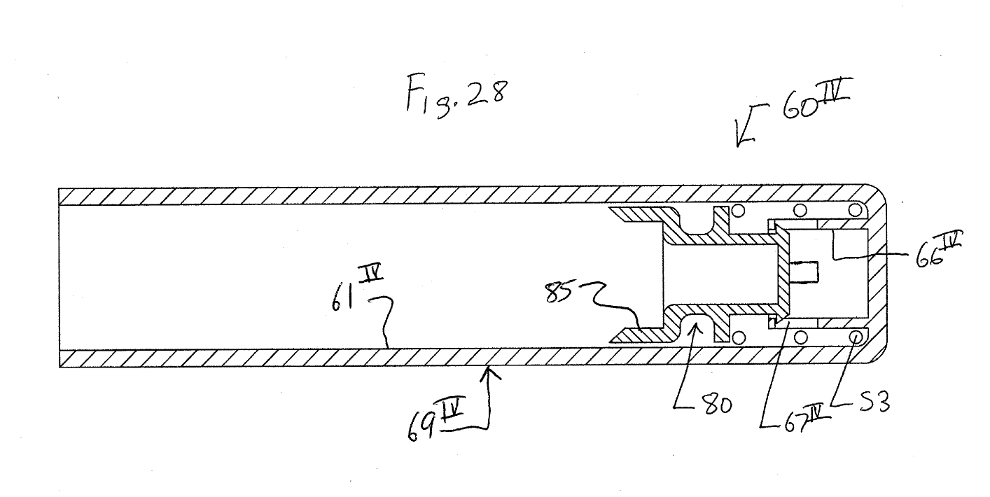

The engagement between the projections 85 and the exterior surface of the pen needle 5 is such that when the cap 60^{IV}.is installed on the injection device 1′ and the safety cap 4 is not installed on the pen needle 5, the engaging member 80 automatically engages with the pen needle 5 by virtue of the spring S3 placing the member 80 in the engagement position (see FIG. 26). Engagement, however, does not occur while the safety cap 4 is installed (see FIG. 27). FIG. 27 illustrates how the removable cap 60^{IV} can be slid onto the injection device 1′ without the projections 85 engaging with the pen needle 5. The position/configuration of FIG. 27, wherein the injection device 1′ has installed thereon the removable cap 60^{IV}, is characteristic of a storage configuration, an initial use configuration, and/or a shipping or packaged configuration. Once the user removes the removable cap 60^{IV}, the user can remove the safety cap 4 and use the device 1′ for injection. Once the device 1′ is used for injection, the user can re-install the removable cap 60^{IV} while the user pen needle 5 is still installed on the device 1′ (see FIG. 26). This renders the device safe or safer to handle as the removable cover 60^{IV} serves to cover the needle of the pen needle 5. The user can then remove the removable cap 60^{IV} to remove the used pen needle 5 from the device 1′. As is apparent from FIG. 26, since the projections 85 engage with the pen needle 5, all the user need do to remove the pen needle 5 from the device 1′ is to rotate the removable cap 60^{IV} along a direction that causes the threads of the pen needle 5 to unthread from section 2′ of the device 1′. Once fully unthreaded, the removable cap 60^{IV} with the used pen needle 5 safely arranged within can be removed from the device 1′. At this point, the user can cause the pen needle 5 to be ejected from within the removable cap 60^{IV} simply by shaking the removable cap 60^{IV} until the pen needle 5 falls out. Since the only mechanism retaining the pen needle 5 within the removable cap 60^{IV} are the projections 85 (which frictionally engage with the external surface of the pen needle 5) shaking the cap 60^{IV} sufficiently causes the pen needle 5 disengaging from the projections 85. At this point, the pen needle 5 can simply fall out of the removable cap 60^{IV} by the user tipping the cap 60^{IV} to the point where the open end is lower than the closed end), and is preferably dropped into a sharps container for safe disposal. Once the used pen needle 5 is removed from the removable cap 60^{IV}, the user can place the cap 60^{IV} back onto the injection device 1′ while the cap 60^{IV} has the configuration shown in FIG. 28.

FIGS. 35-37 show an optional engaging member 80′ that can be used in the removable cap 60^{IV} shown in FIG. 28. As shown in FIGS. 35-37, the engaging member 80′ includes a proximal end 81′, a support ring 83′, a main generally cylindrical open area 84′, a distal end 87′, plural engaging members 85′, i.e., four engaging members, having tapered ends 86′, and can slide within the cap 60^{IV}.

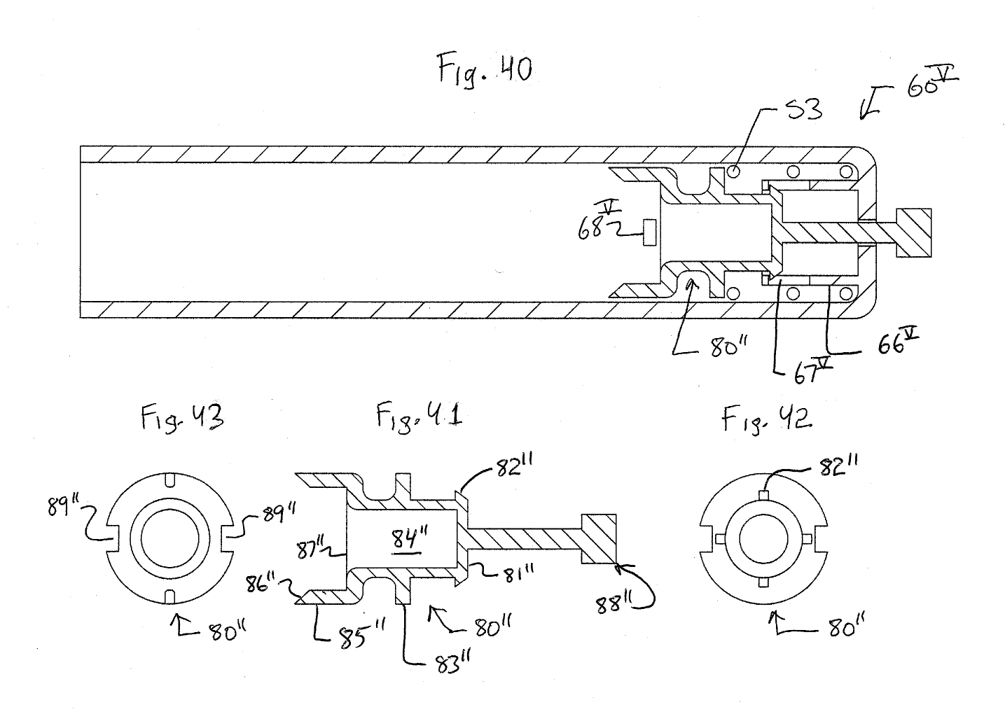

FIGS. 38-42 show another embodiment of a removable cap or removable cap assembly according to the invention. The removable cap 60^{V} includes a generally cylindrical main body 69^{V}. In embodiments, the main body 69^{V} is a one-piece integrally formed member. A clip C (not shown) is coupled to the main body 69^{V} so as to allow for clipping onto a user. The main body 69^{V} also includes a generally cylindrical section 61^{V} sized and configured to slide onto a proximal end of a pen injection device 1′ (not shown in FIGS. 38 and 39). The main body 69^{V} also includes an inner support 66^{V} having a plurality of generally radially oriented slots 67^{V} sized and configured to slidably receive therein a plurality of projections 82″ arranged on an engaging member 80″. A spring S3 biases the engaging member 80″ towards the engaging position (see FIG. 38) wherein engaging members 85″ engage with recesses formed on the pen needle 5. As shown in FIGS. 41-43, the engaging member 80″ includes a proximal end 81″, a support ring 83″, a main generally cylindrical open area 84″, a distal end 87″, plural engaging members 85″, i.e., two engaging members, having tapered ends 86″, plural slots 89″, i.e., two slots, that allow the ring 83″ to pass by retaining projection 68^{V} upon installation. The engaging member 80″ also includes a proximal gripping end 88″ which allows the user to move the member 80″ from outside the cap 60^{V}. The member 80″ can slide axially within the cap 60^{V} between an extended and/or initial position and/or engaging position shown in FIG. 38 and a retracted position shown in FIG. 39

The engagement between the projections 85″ and the exterior surface of the pen needle 5 is such that when the cap 60^{V}.is installed on the injection device 1′ (not shown in FIGS. 38 and 39) and the safety cap 4 (not shown) is not installed on the pen needle 5, the engaging member 80″ automatically engages with the pen needle 5 by virtue of the spring S3 placing the member 80″ in the engagement position (see FIG. 38). Engagement, however, does not occur while the safety cap 4 is installed (in the same was as shown FIG. 27). Once the user removes the removable cap 60^{V}, the user can remove the safety cap 4 and use the device 1′ for injection. Once the device 1′ is used for injection, the user can re-install the removable cap 60^{V} while the user pen needle 5 is still installed on the device 1′ (as shown in FIG. 38 but not showing the device 1′). This renders the device safe or safer to handle as the removable cover 60^{V} serves to cover the needle of the pen needle 5. The user can then remove the removable cap 60^{V} to remove the used pen needle 5 from the device 1′. As is apparent from FIG. 38, since the projections 85″ engage with the pen needle 5, all the user need do to remove the pen needle 5 from the device 1′ is to rotate the removable cap 60^{V} along a direction that causes the threads of the pen needle 5 to unthread from section 2′ of the device 1′. Once fully unthreaded, the removable cap 60^{V} with the used pen needle 5 safely arranged within can be removed from the device 1′. At this point, the user can cause the pen needle 5 to be ejected from within the removable cap 60^{V} simply by shaking the removable cap 60^{V} until the pen needle 5 falls out. However, with this embodiment, the user can also pull on the member 88″ in the direction of the arrow shown in FIG. 39 to cause the members 85″ to disengage from the pen needle 5. This disengagement will be facilitated by the projections 68^{V} as they stop or prevent axial movement (along the direction of arrow in FIG. 39) of the pen needle 5. At this point, the pen needle 5 can simply fall out of the removable cap 60^{V} by the user tipping the cap 60^{V} to the point where the open end is lower than the closed end), and is preferably dropped into a sharps container for safe disposal. Once the used pen needle 5 is removed from the removable cap 60^{V}, the user can place the cap 60^{V} back onto the injection device 1′ while the cap 60^{V} has the configuration shown in FIG. 40. To facilitate installation of the member 80″ into the cap 60^{V}, the member 88″ can be made separate from the body of the member 80″ so that a distal end of the member 88″ is threaded into the end 81″ (not shown). Alternatively, the opening in the proximal end of the cap body 69 can be made large enough so that the gripping end of the member 88″ passes there through (not shown).

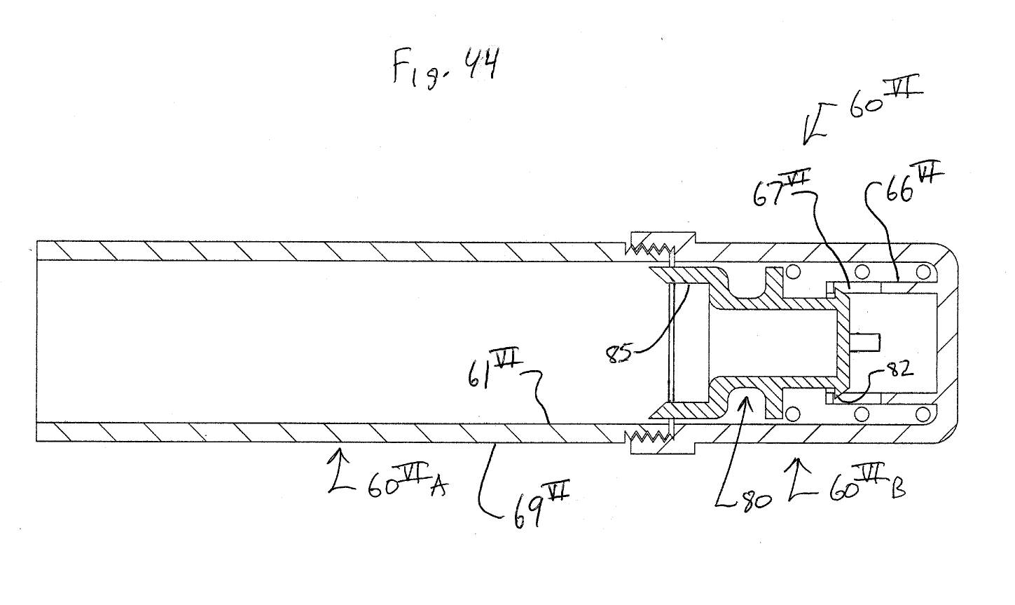

FIGS. 44-46 shows another embodiment of a removable cap or removable cap assembly according to the invention. The removable cap 60^{VI} includes a generally cylindrical main body 69^{VI}. In embodiments, the cap 60^{VI} is a two-piece member including a distal part 60^{VI}A and threadably and removable connected proximal part 60^{VI}B. A clip C (not shown) is coupled to the main body so as to allow for clipping onto a user. The distal part 60^{VI}A includes a generally cylindrical section 61^{VI} sized and configured to slide onto a proximal end of a pen injection device 1′. The proximal part 69^{VI}B includes an inner support 66^{VI} having a plurality of generally radially oriented slots 67^{VI} sized and configured to slidably receive therein a plurality of projections 82 arranged on an engaging member 80. A spring S3 biases the engaging member 80 towards the engaging position (see FIG. 44) wherein engaging members 85 engage with recesses formed on the pen needle 5. The cap assembly shown in FIGS. 44-46 functions similar to that shown in FIGS. 26-28 except that it can be separated to allow the user to grip the pen needle 5 and remove it from the proximal part 60^{VI}B. That is, once the user removes the cap assembly from the injection device (by using it to unthread the pen needle 5) so that it assumes the configuration shown in FIG. 45, the user can unthread the proximal part 60^{VI}B from the distal part 60^{VI}A as shown in FIG. 46 and then manually remove the pen needle 5 from the proximal part 60^{VI}B for proper disposal of the pen needle 5. The user can then reconnect the proximal part 60^{VI}B to the distal part 60^{VI}A so that the cap assembly can again assume the ready-to-use configuration shown in FIG. 44.

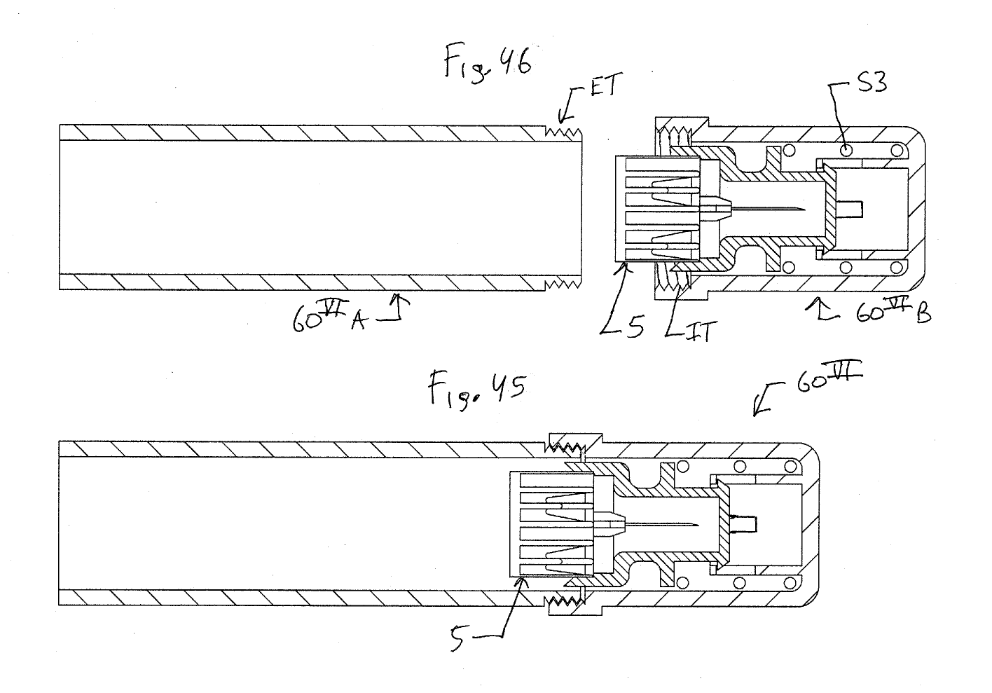

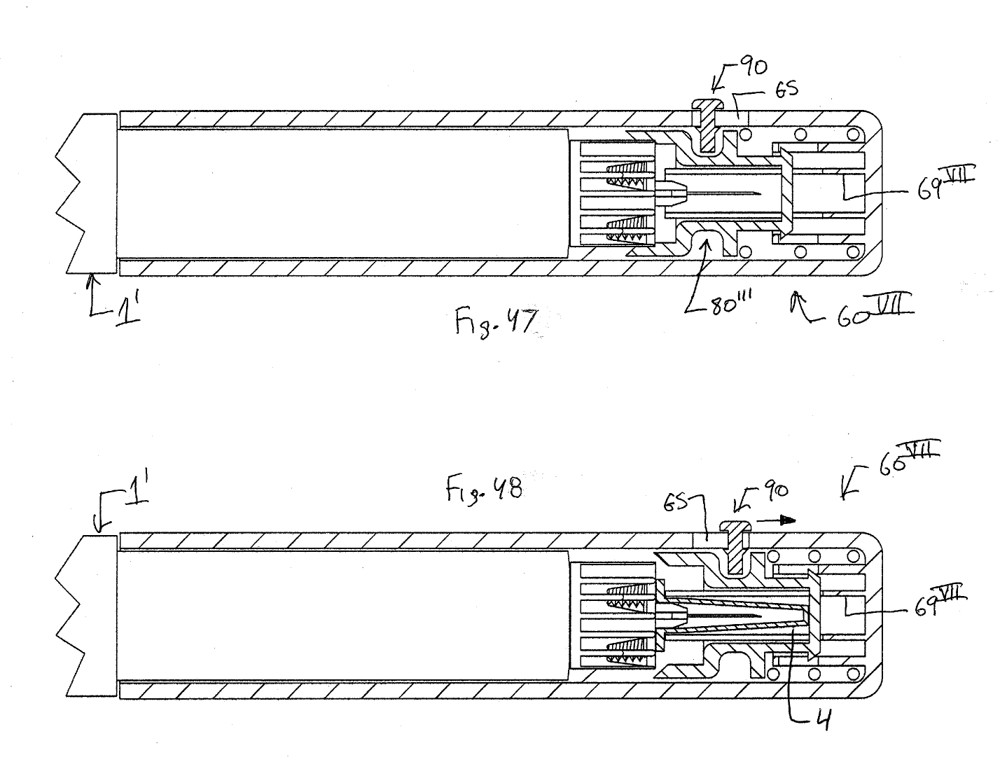

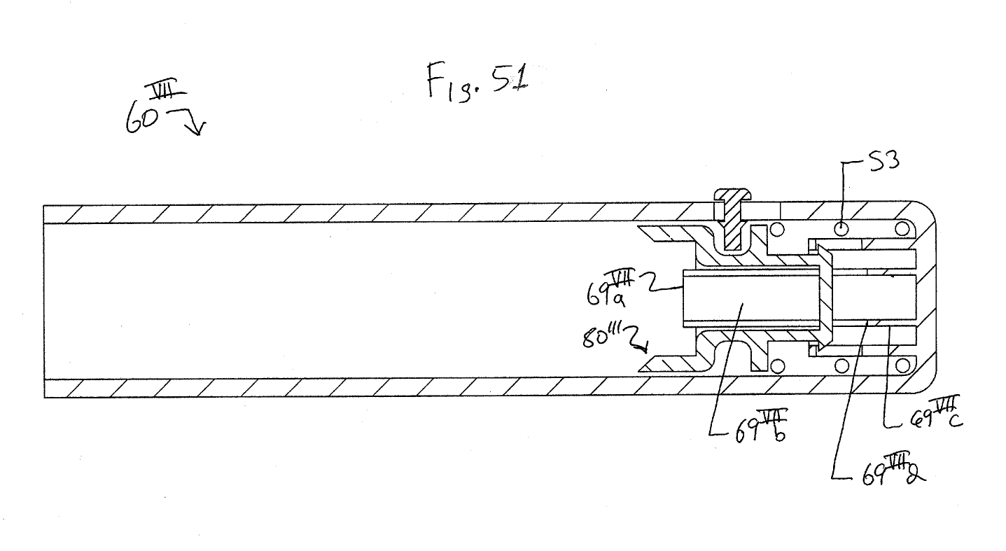

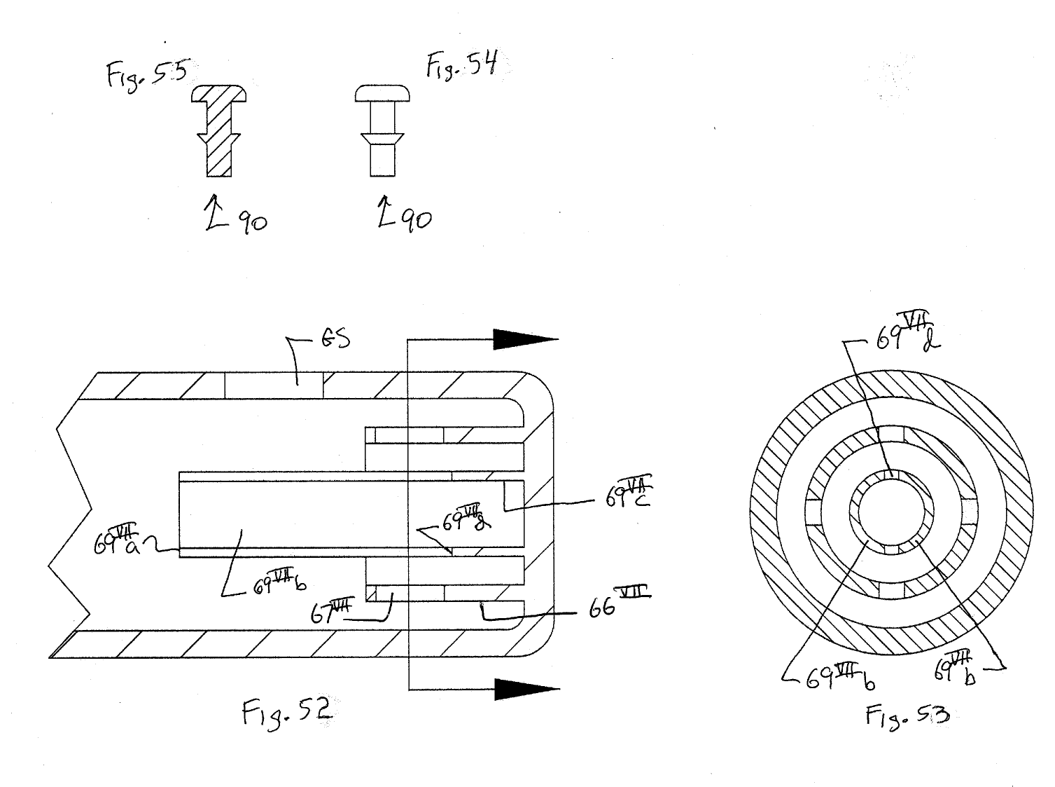

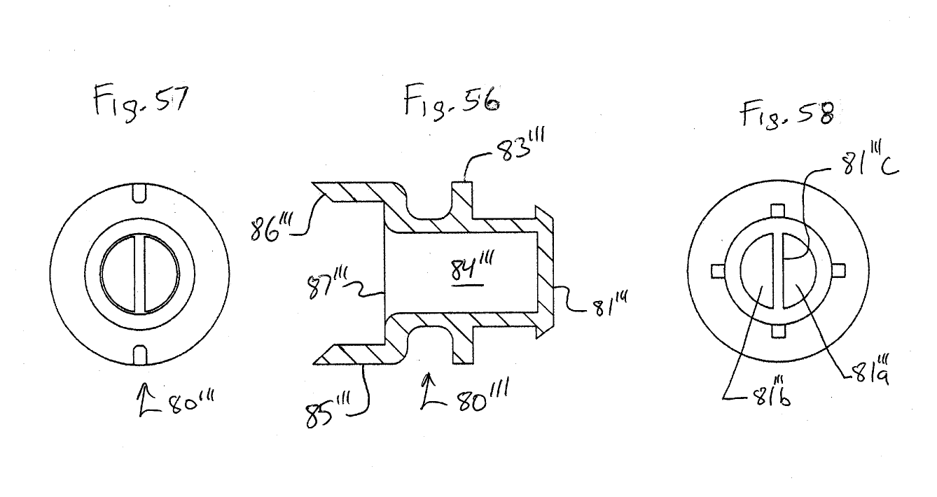

FIGS. 47-58 show another embodiment of a removable cap or removable cap assembly according to the invention. The removable cap 60^{VII} includes a generally cylindrical main body 69^{VII}. In embodiments, the main body 69^{VII} is a one-piece integrally formed member. A clip C (not shown) is coupled to the main body 69^{VII} so as to allow for clipping onto a user. The main body 69^{VII} also includes a generally cylindrical section 61^{VII} sized and configured to slide onto a proximal end of a pen injection device 1′ (see FIGS. 47 and 48). The main body 69^{VII} also includes an inner support 66^{VII} having a plurality of generally radially oriented slots 67^{VII} sized and configured to slidably receive therein a plurality of projections 82′″ arranged on an engaging member 80′″. The main body 69^{VII} further also includes a smaller inner support 69^{VII} having a plurality of generally radially oriented slots 69^{VII} sized and configured to slidably receive therein a main rib 81′″c arranged on the engaging member 80′″. A spring S3 biases the engaging member 80′″ towards the engaging position (see FIG. 47) wherein engaging members 85′″ engage with recesses formed on the pen needle 5. A finger actuated slide 90 is movably arranged on the cap assembly and allows a user to move the member 80′″ between the extended position shown in FIG. 47 and the retracted position shown in FIG. 48. As can be seen in FIGS. 54 and 55, the slide member 90 has a button portion and a portion which extends into the guide slot GS and engages with the member 80′″. As shown in FIGS. 56-58, the engaging member 80′″ includes a proximal end 81′″, a support ring 83′″, a main generally cylindrical open area 84′″, a distal end 87′″, plural engaging members 85′″, i.e., two engaging members, having tapered ends 86′″, plural openings 81′″a and 81′″b, a connecting rib 81′″c, and can slide within the cap 60^{VII}.

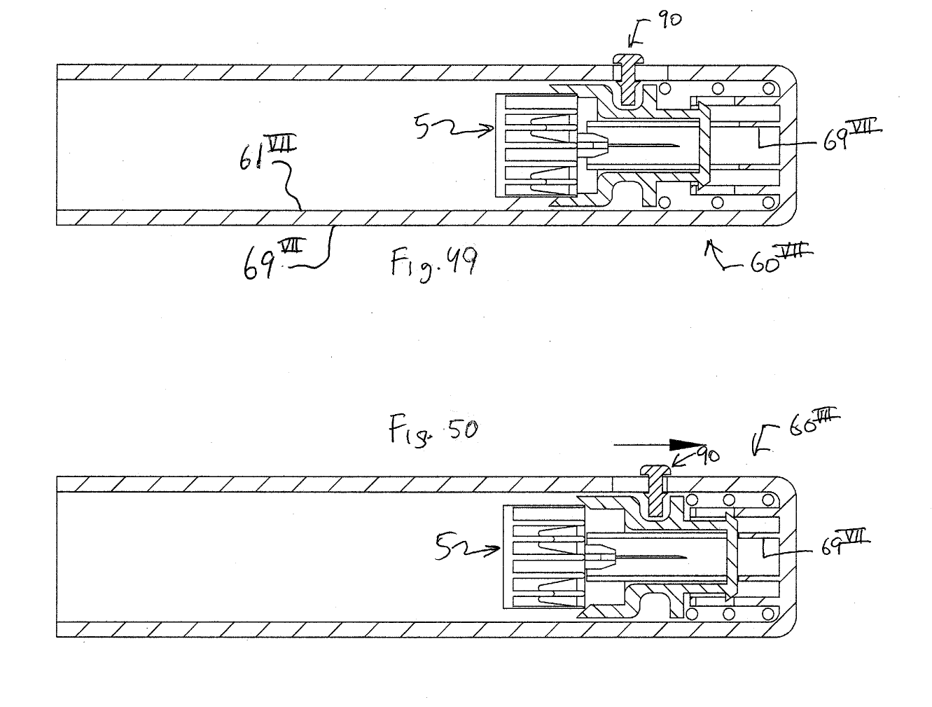

The engagement between the projections 85′″ and the exterior surface of the pen needle 5 is such that when the cap 60^{VII}.is installed on the injection device 1′ and the safety cap 4 is not installed on the pen needle 5, the engaging member 80′″ automatically engages with the pen needle 5 by virtue of the spring S3 placing the member 80′″ in the engagement position (see FIG. 47). Engagement, however, does not occur while the safety cap 4 is installed (see FIG. 48). FIG. 48 illustrates how the removable cap 60^{VII} can be slid onto the injection device 1′ without the projections 85′″ engaging with the pen needle 5. The position/configuration of FIG. 48, wherein the injection device 1′ has installed thereon the removable cap 60^{VII}, is characteristic of a storage configuration, an initial use configuration, and/or a shipping or packaged configuration. Once the user removes the removable cap 60^{VII}, the user can remove the safety cap 4 and use the device 1′ for injection. Once the device 1′ is used for injection, the user can re-install the removable cap 60^{VII} while the user pen needle 5 is still installed on the device 1′ (see FIG. 47). This renders the device safe or safer to handle as the removable cover 60^{VII} serves to cover the needle of the pen needle 5. The user can then remove the removable cap 60^{VII} to remove the used pen needle 5 from the device 1′. As is apparent from FIG. 47, since the projections 85′″ engage with the pen needle 5, all the user need do to remove the pen needle 5 from the device 1′ is to rotate the removable cap 60^{VII} along a direction that causes the threads of the pen needle 5 to unthread from section 2′ of the device 1′. Once fully unthreaded, the removable cap 60^{VII} with the used pen needle 5 safely arranged within can be removed from the device 1′ so that it assumes the configuration shown in FIG. 49. At this point, the user can cause the pen needle 5 to be ejected from within the removable cap 60^{VII} simply by shaking the removable cap 60^{VII} until the pen needle 5 falls out. Preferably, however, the user can slide the member 90 along the direction of arrow as shown in FIG. 50. While this movement will move the member 80′″ along the same direction which in turn moves the pen needle 5 also, once the pen needle 5 contacts the ends 69^{VII}a of the members 69^{VII}b, further movement of the member 80′″ causes the members 85′″ to disengage from the pen needle 5 as shown in FIG. 50. A shoulder 69^{VII}d limits movement of the member 80′″ along this ejection/disengagement movement. Since the only mechanism retaining the pen needle 5 within the removable cap 60^{VII} are the projections 85′″ (which frictionally engage with the external surface of the pen needle 5), this movement causes the pen needle 5 disengaging from the projections 85′″. At this point, the pen needle 5 can simply fall out of the removable cap 60^{VII} by the user tipping the cap 60^{VII} to the point where the open end is lower than the closed end), and is preferably dropped into a sharps container for safe disposal. Once the used pen needle 5 is removed from the removable cap 60^{VII}, the user can place the cap 60^{VII} back onto the injection device 1′ while the cap 60^{VII} has the configuration shown in FIG. 51.

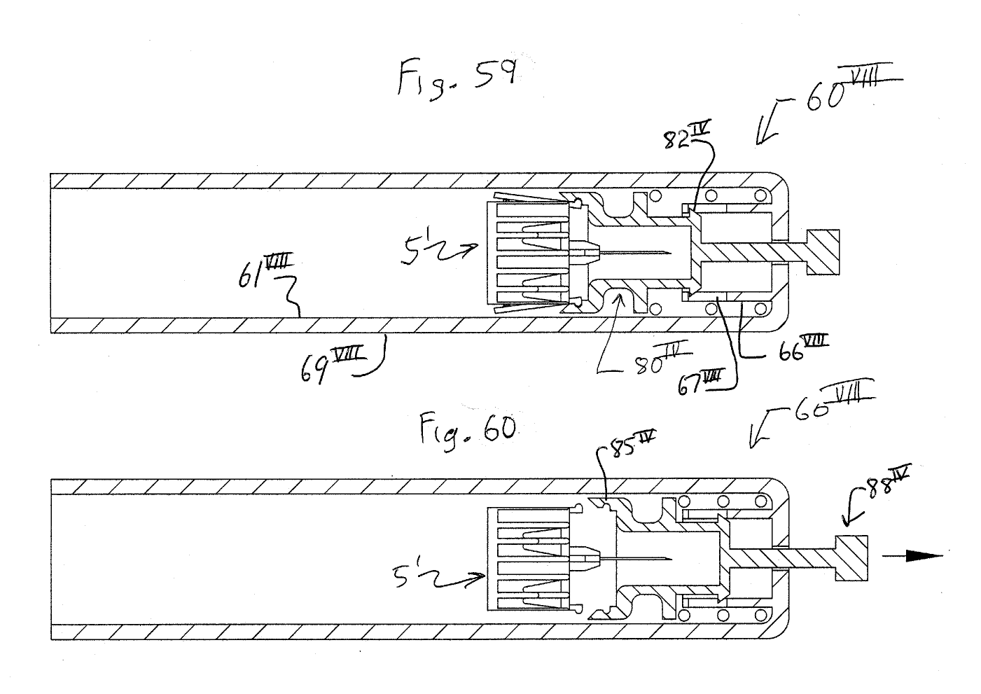

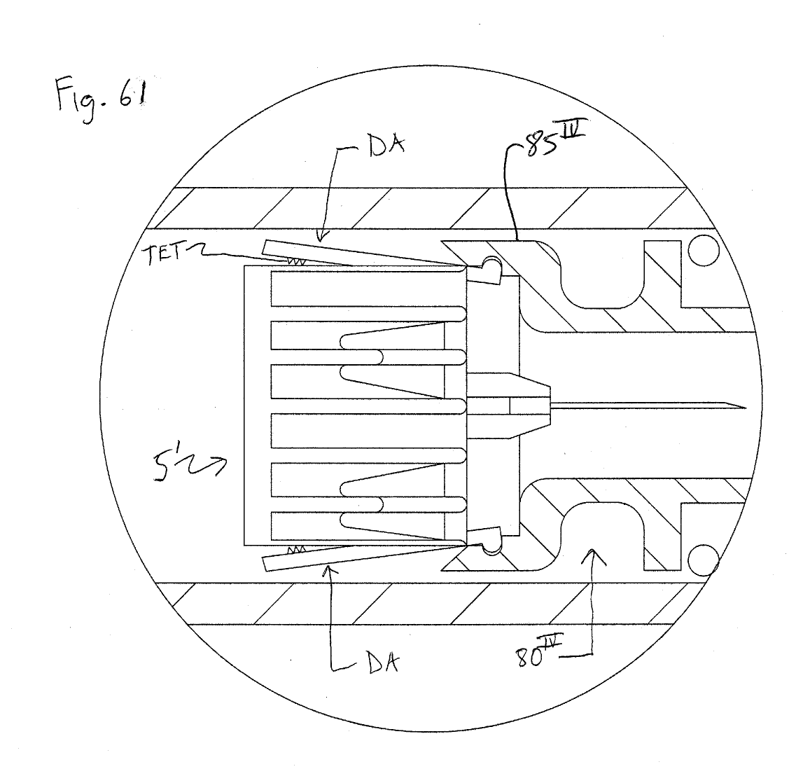

FIGS. 59-61 show another embodiment of a removable cap or removable cap assembly according to the invention. The removable cap 60^{VIII} includes a generally cylindrical main body 69^{VIII}. In embodiments, the main body 69^{VIII} is a one-piece integrally formed member. A clip C (not shown) is coupled to the main body 69^{VIII} so as to allow for clipping onto a user. The main body 69^{VIII} also includes a generally cylindrical section 61^{VIII} sized and configured to slide onto a proximal end of a pen injection device 1′ (not shown in FIGS. 59 and 60). The main body 69^{VIII} also includes an inner support 66^{VIII} having a plurality of generally radially oriented slots 67^{VIII} sized and configured to slidably receive therein a plurality of projections 82″ arranged on an engaging member 80^{IV}. A spring S3 biases the engaging member 80^{IV} towards the engaging position (see FIG. 59) wherein engaging members 85^{IV} engage with deflectable members DA arranged on the pen needle 5′. The engaging member 80^{IV} includes a proximal gripping end 88^{IV} which allows the user to move the member 80^{IV} from outside the cap 60^{VIII}. The member 80^{IV} can slide axially within the cap 60^{VIII} between an extended and/or initial position and/or engaging position shown in FIG. 59 and a retracted position shown in FIG. 60. In order to allow the members 85^{IV} to disengage from the members DA of the pen needle 5′, when the user moves member 88^{IV} along the direction of arrow shown in FIG. 60, plural projections (not shown but similar to projections 68^{V} shown in FIG. 40) stop axial movement of the pen needle 5′ so that the members 85^{IV} can disengage from the members DA as shown in FIG. 60. As can be seen in FIG. 61, when the members 85^{IV} are engaged with the members DA of the pen needle 5′, the threaded portions TET (which are the only portions of the pen needle 5′ in threaded engagement with the threaded section 2′) are deflected out of engagement with the threaded section 2′ of the device 1′ allowing the pen needle 5′ to be slid off of the device 1′.

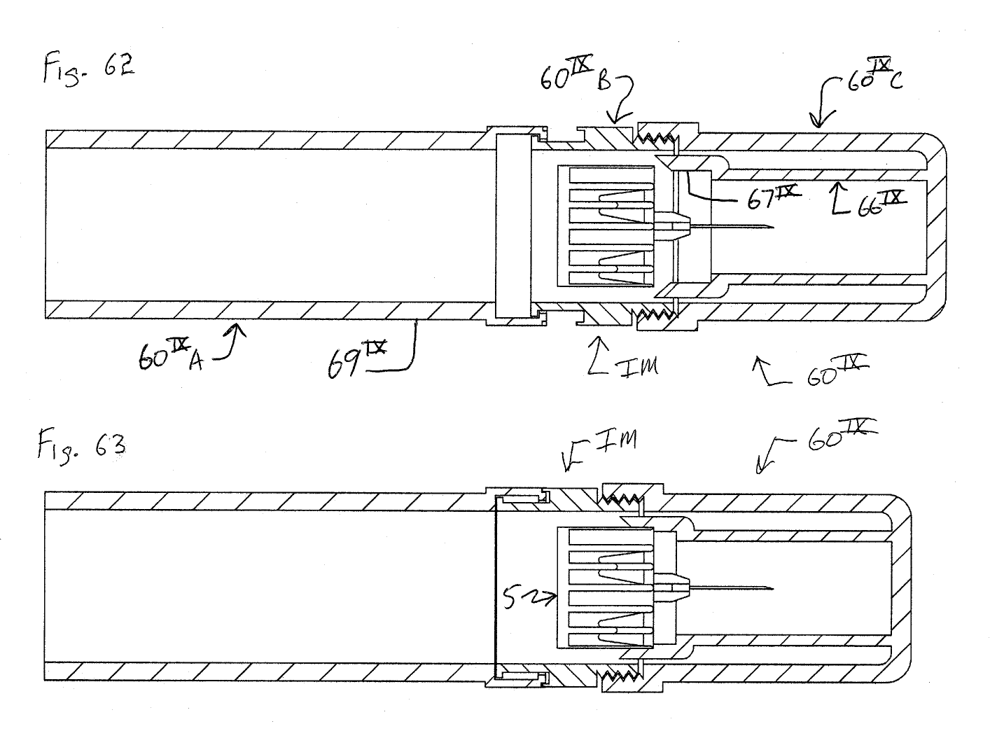

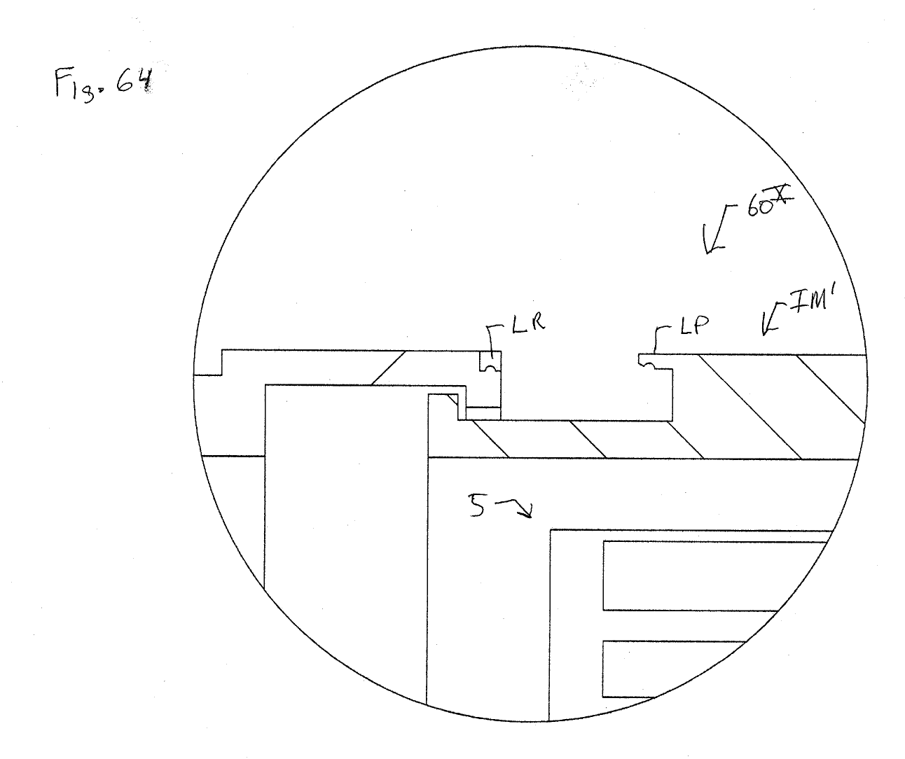

FIGS. 62-64 shows other embodiments of a removable cap or removable cap assembly according to the invention. The removable cap 60^{IX} includes a generally cylindrical main body 69^{IX}. In embodiments, the cap 60^{IX} is a three-piece member including a distal part 60^{IX}A, an intermediate part 60^{IX}B, and threadably and removable connected proximal part 60^{IX}C. A clip C (not shown) is coupled to the main body so as to allow for clipping onto a user. The distal part 60^{IX}A includes a generally cylindrical section sized and configured to slide onto a proximal end of a pen injection device 1′. The proximal part 69^{IX}C includes an inner support 66^{IX} having a plurality of engaging members 67^{IX} which function to engage with the pen needle 5. The intermediate part 69^{IX}B is an intermediate member IM which can move axially and optionally lock (via locking projection LP and locking recess LR in FIG. 64) to the distal part 60^{IX}A and can unthread from the proximal part 69^{IX}C. The cap assembly shown in FIGS. 62-64 functions similar to that shown in FIG. 44 except that it can be expanded, via intermediate member IM, and separated to allow the user to grip the pen needle 5 and remove it from the proximal part 60^{IX}C. That is, once the user removes the cap assembly from the injection device (by using it to unthread the pen needle 5) so that it assumes the configuration shown in FIG. 63, the user can then move the proximal part 60^{IX}C away from the distal part 60^{IX}A as shown in FIG. 62 and then either allow the pen needle 5 to fall out or manually unthread the proximal part 60^{IX}C from the intermediate part 60^{IX}B, and then remove the pen needle 5 from the proximal part 60^{IX}C for proper disposal of the pen needle 5. The user can then reconnect the proximal part 60^{IX}C to the intermediate part 60^{IX}B and place the cap assembly in the position shown in FIG. 63 so that the cap assembly can again assume a ready-to-use configuration. In order to allow the members 67^{IX} to disengage from the pen needle 5′, when the user moves member 60^{IX}C from that shown in FIG. 63 to that shown in FIG. 62, plural projections (not shown but similar to projections 68^{V} shown in FIG. 40) are arranged on member IM and stop axial movement of the pen needle 5 so that the members 67^{IX} can disengage from the pen needle 5 as shown in FIG. 62.

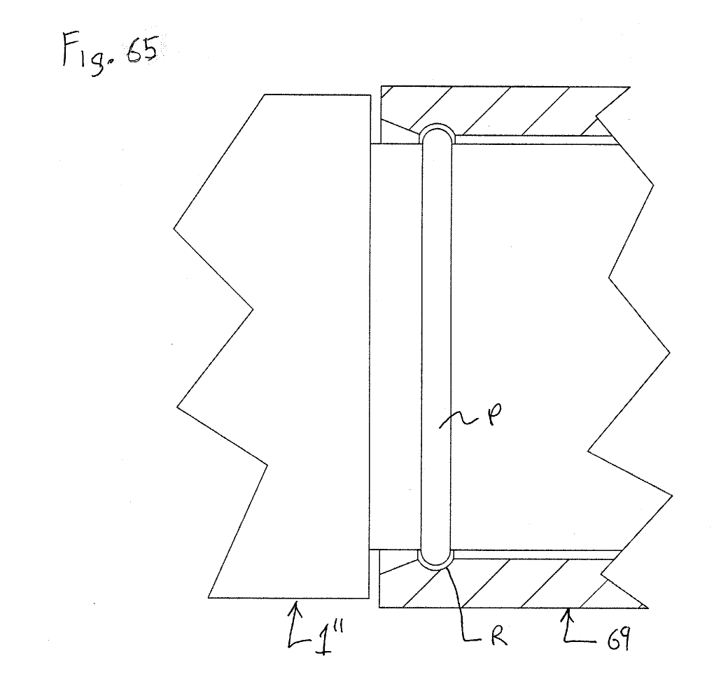

FIG. 65 show one non-limiting way in which the removable cap of the types described herein can be releasably connected to a pen needle device. In this embodiment, the main body 69 has a recess R which can receivingly retain therein a projection P arranged on the device 1″. Other snap-type connections can also be utilized to releasably retain the cap assembly on the device 1″.

The devices described herein can also utilize one or more features disclosed in prior art documents expressly incorporated by reference in pending U.S. patent application Ser. No. 11/616,195 (Publication No. 2008/0154192). This application and the documents expressly incorporated therein is hereby expressly incorporated by reference in the instant application. Furthermore, one or more of the various parts of the device can preferably be made as one-piece structures by e.g., injection molding, when doing so reduces costs of manufacture. Non-limiting materials for most of the parts include synthetic resins such as those approved for syringes, blood collection devices, or other medical devices. Furthermore, the invention also contemplates that any or all disclosed features of one embodiment may be used on other disclosed embodiments, to the extent such modifications function for their intended purpose.

purpose.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An injection device cap comprising:
a cap body configured to remove a pen needle installed on the injection device.

2. The cap of claim 1, wherein the cap body comprises a plurality of mechanisms for engaging portions of the pen needle.

3. The cap of claim 2, wherein at least one of:
the plurality of mechanisms ensure that when a user rotates the cap body, the pen needle is caused to rotate or un-thread from an injection device;
the plurality of mechanisms comprise radial projections which engage with radial recesses of the pen needle; and
the plurality of mechanisms comprise inwardly oriented radial projections which engage with external recesses of the pen needle.

4. The cap of claim 1, wherein the cap body comprises at least one of:
a device for removing the pen needle from the cap body;
a device for ejecting the pen needle from the cap body;
a device for ejecting the pen needle from within the cap body.

5. The cap of claim 1, wherein the cap body comprises a user activated device for ejecting the pen needle from within the cap body.

6. The cap of claim 1, wherein the cap body comprises a clip for removably securing an injection device to a user's garment.

7. The cap of claim 1, wherein the cap body is installable onto an injection device when with the pen needle is installed on the injection device.

8. The cap of claim 7, wherein the cap body does not rotatably engage with the pen needle when a needle cap of the pen needle is installed thereon and the cap body does rotatably engage with the pen needle when the needle cap of the pen needle is removed.

9. The cap of claim 8, wherein the cap body comprises a user activated device for ejecting the pen needle from within the cap body.

10. The cap of claim 1, wherein the cap body rotatably engages with the pen needle when a needle cap of the pen needle is removed and the cap body does not rotatably engage with the pen needle when the needle cap of the pen needle is not removed.

11. The cap of claim 1, wherein at least one of:
the cap body comprises a device for indicating to a user that the cap body is and/or is not rotatably engaged with the pen needle;
the cap body comprises a visual indicator which indicates to a user that the cap body is and/or is not rotatably engaged with the pen needle; and
the cap body comprises a system for preventing rotatable engagement with the pen needle when a needle cap of the pen needle is installed thereon and for automatically causing rotatable engagement with the pen needle when the needle cap of the pen needle is removed; and
the cap body comprises a user activated device for ejecting the pen needle from within the cap body.

12. The cap of claim 1, wherein the cap body comprises a system for preventing rotatable engagement with the pen needle when a needle cap of the pen needle is installed thereon and a system for automatically causing rotatable engagement with the pen needle when the needle cap of the pen needle is removed.

13. The cap of claim 1, wherein the cap body comprises a plural-part cap body.

14. The cap of claim 1, wherein the cap body comprises a user activatable system for preventing engagement with the pen needle and for causing engagement with the pen needle.

15. The cap of claim 1, wherein the cap body comprises a user activatable system for preventing locking engagement with the pen needle and for causing locking engagement with the pen needle.

16. The cap of claim 1, wherein the cap body comprises a user activatable system for causing locking engagement between the cap body and the pen needle.

17. The cap of claim 1, wherein one of:
at least two parts of the three-part cap body are arranged to rotate freely with respect to one another in one position and to prevent relative rotation in another position;
at least two parts of the three-part cap body are arranged to rotate freely with respect to one another in one position and to releasably lock together in another position; and
at least two of parts of the three-part cap body are connected to each other via a threaded connection.

18. The cap of claim 1, wherein the injection device is one of a pre-filed injection device, a pen injection device, and an insulin injection device.

19. A method of removing a pen needle from an injection device using the cap of claim 1, the method comprising:
installing the pen needle onto a proximal end of an injection device;
removing the pen needle using the cap.

20. A pre-filled injection device comprising:
a pre-filled injection device body; and
a removable cap configured to remove a pen needle installed on the pre-filled injection device body.
